(19) United States
(12) Patent Application Publication
(10) Pub. No.: US 2019/0294642 A1
(43) Pub. Date: Sep. 26, 2019

(54) WEBSITE FINGERPRINTING

(71) Applicant: Bombora, Inc., New York, NY (US)

(72) Inventors: Erik G. Matlick, Miami Beach, FL (US); Robert J. Armstrong, Reno, NV (US); Nicholaus Eugene Halecky, Reno, NV (US); Benny Lin, New York, NY (US)

(21) Appl. No.: 16/435,382

(22) Filed: Jun. 7, 2019

Related U.S. Application Data
(63) Continuation-in-part of application No. 16/109,648, filed on Aug. 22, 2018.
(60) Provisional application No. 62/549,812, filed on Aug. 24, 2017.

(51) Int. Cl. G06F 16/951; G06F 16/955; G06F 16/958

(52) U.S. Cl. CPC G06F 16/951; G06F 16/958; G06F 16/955

(57) ABSTRACT

A website classification system identifies one or more features in websites and uses the features to classify the websites. The website classification system may generate features identifying structural semantics of webpages, content semantics of webpages, content interaction behavior with the webpages, or types of users accessing the webpages. The website classification system may generate vectors that represent the different features. A first set of vectors from classified websites are used for training a computer learning model. Vectors from unclassified websites are then fed into the trained learning model to predict a particular website classification. The predicted website classifications provide more accurate intent, consumption, and surge score predictions.

The present application is a continuation in part of U.S. patent application Ser. No. 16/109,648, entitled: WEBSITE INTEREST DETECTOR, filed Aug. 22, 2018, which claims priority to U.S. Provisional Patent Application Ser. No. 62/549,812, filed Aug. 24, 2017 entitled: CLASSIFYING SOURCES OF CONTENT CONSUMPTION, which are all incorporated by reference in their entireties.

### BACKGROUND

Users receive a random variety of different information from a random variety of different businesses. For example, users may constantly receive promotional announcements, advertisements, information notices, event notifications, etc. Users request some of this information. For example, a user may register on a company website to receive sales or information announcements. However, much of the information is of little or no interest to the user. For example, the user may receive emails announcing every upcoming seminar, regardless of the subject matter.

The user also may receive unsolicited information. For example, a user may register on a website to download a white paper on a particular subject. A lead service then may sell the email address to companies that send the user unsolicited advertisements. Users end up ignoring most or all of these emails since most of the information has no relevance or interest. Alternatively, the user directs all of these emails into a junk email folder.

### BRIEF DESCRIPTION OF THE DRAWINGS

FIG. 1 depicts an example content consumption monitor (CCM).

FIG. 2 depicts an example of the CCM in more detail.

FIG. 3 depicts an example operation of a CCM tag.

FIG. 4 depicts example events processed by the CCM.

FIG. 5 depicts an example user intent vector.

FIG. 6 depicts an example process for segmenting users.

FIG. 7 depicts an example process for generating company intent vectors.

FIG. 8 depicts an example consumption score generator.

FIG. 9 depicts the example consumption score generator in more detail.

FIG. 10 depicts an example process for identifying a surge in consumption scores.

FIG. 11 depicts an example process for calculating initial consumption scores.

FIG. 12 depicts an example process for adjusting the initial consumption scores based on historic baseline events.

FIG. 13 depicts an example process for mapping surge topics with contacts.

FIG. 14 depicts an example content consumption monitor calculating content intent.

FIG. 15 depicts an example process for adjusting a consumption score based on content intent.

FIG. 16 depicts an example of the site classifier in more detail.

FIG. 17 depicts an example process for site classification.

FIG. 18 depicts an example CCM that uses a site classifier.

FIG. 19 depicts an example structural semantic network graph for webpages.

FIG. 20 depicts example features generated for the webpages of FIG. 19.

FIG. 21 depicts example vector embeddings generated for the features of FIG. 20.

FIG. 22 depicts an example computer learning model trained using the vector embeddings of FIG. 21.

FIG. 23 depicts an example computer learning model configured to classify websites based on associated vector embeddings.

FIG. 24 depicts an example computing device used for classifying websites.

### DETAILED DESCRIPTION

Site fingerprinting uses a computer learning model to predict website classes, such as news websites, vendor websites, and marketer websites. The website classifications allow a content consumption monitor (CCM) 100 to distinguish user-content-interactions by class of website, identify new/unknown websites having similarity to a desired class, and generally better understand website content. Due to the sheer scale of networks, with millions of web pages with likely billions of connections, traditional graph embedding techniques cannot scale. Thus, a novel vector embedding is used for representing different webpage features and predicting website classes.

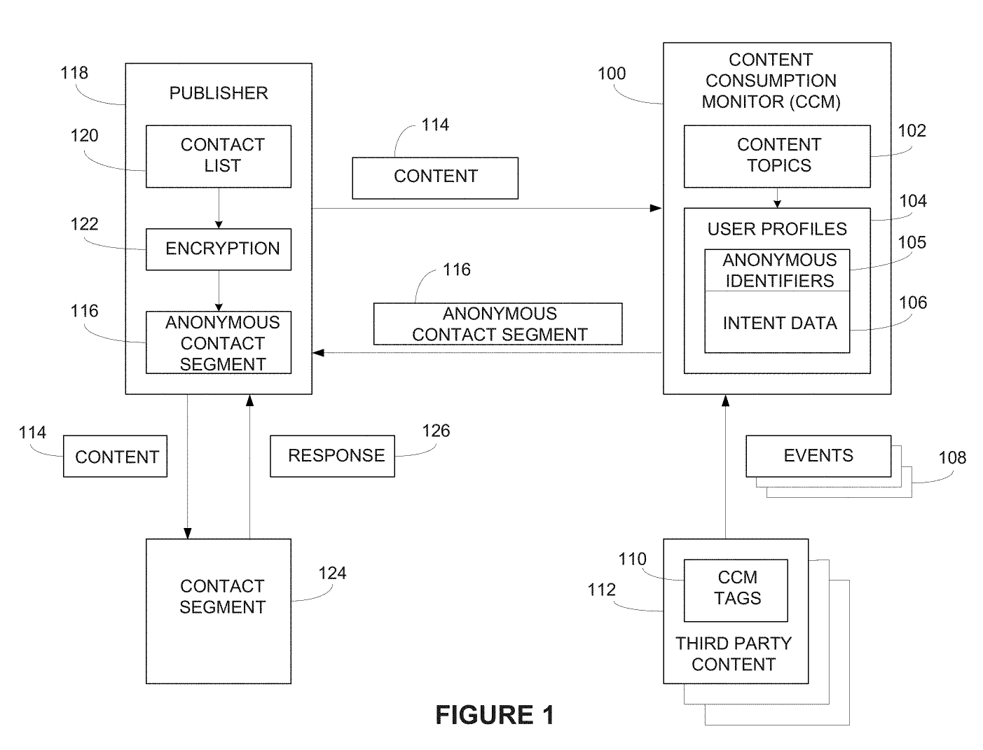

FIG. 1 depicts a content consumption monitor (CCM) 100. CCM 100 may be a server or any other computing system that communicates with a publisher 118 and monitors user accesses to third party content 112. Publisher 118 is any server or computer operated by a company or individual that wants to send content 114 to an interested group of users. This group of users is alternatively referred to as contact segment 124.

For example, publisher 118 may be a company that sells electric cars. Publisher 118 may have a contact list 120 of email addresses for customers that have attended prior seminars or have registered on the publisher website. Contact list 120 also may be generated by CCM tags 110 that are described in more detail below. Publisher 118 also may generate contact list 120 from lead lists provided by third parties lead services, retail outlets, and/or other promotions or points of sale, or the like or any combination thereof. Publisher 118 may want to send email announcements for an upcoming electric car seminar. Publisher 118 would like to increase the number of attendees at the seminar.

Third party content 112 comprises any information on any subject accessed by any user. Third party content 112 may include web pages provided on website servers operated by different businesses and/or individuals. For example, third party content 112 may come from different websites operated by on-line retailers and wholesalers, on-line newspapers, universities, blogs, municipalities, social media sites, or any other entity that supplies content.

Third party content 112 also may include information not accessed directly from websites. For example, users may access registration information at seminars, retail stores, and other events. Third party content 112 also may include content provided by publisher 118.

Computers and/or servers associated with publisher 118, content segment 124, CCM 100 and third-party content 112 may communicate over the Internet or any other wired or wireless network including local area networks (LANs), wide area networks (WANs), wireless networks, cellular networks, Wi-Fi networks, Bluetooth® networks, cable networks, or the like, or any combination thereof.

Some of third party content 112 may contain CCM tags 110 that capture and send events 108 to CCM 100. For example, CCM tags 110 may comprise JavaScript added to website web pages. The website downloads the web pages, along with CCM tags 110, to user computers. User computers may include any communication and/or processing device including but not limited to laptop computers, personal computers, smart phones, terminals, tablet computers, or the like, or any combination thereof. CCM tags 110 monitor web sessions send some captured web session events 108 to CCM 100.

Events 108 may identify third party content 112 and identify the user accessing third party content 112. For example, event 108 may include a universal resource locator (URL) link to third party content 112 and may include a hashed user email address or cookie identifier associated with the user that accessed third party content 112. Events 108 also may identify an access activity associated with third party content 112. For example, event 108 may indicate the user viewed a web page, downloaded an electronic document, or registered for a seminar.

CCM 100 builds user profiles 104 from events 108. User profiles 104 may include anonymous identifiers 105 that associate third party content 112 with particular users. User profiles 104 also may include intent data 106 that identifies topics in third party content 112 accessed by the users. For example, intent data 106 may comprise a user intent vector that identifies the topics and identifies levels of user interest in the topics.

As mentioned above, publisher 118 may want to send an email announcing an electric car seminar to a particular contact segment 124 of users interested in electric cars. Publisher 118 may send the email as content 114 to CCM 100. CCM 100 identifies topics 102 in content 114.

CCM 100 compares content topics 102 with intent data 106. CCM 100 identifies the user profiles 104 that indicate an interest in content 114. CCM 100 sends anonymous identifiers 105 for the identified user profiles 104 to publisher 118 as anonymous contact segment 116.

Contact list 120 may include user identifiers, such as email addresses, names, phone numbers, or the like, or any combination thereof. The identifiers in contact list 120 are hashed or otherwise de-identified by an algorithm 122. Publisher 118 compares the hashed identifiers from contact list 120 with the anonymous identifiers 105 in anonymous contact segment 116.

Any matching identifiers are identified as contact segment 124. Publisher 118 identifies the unencrypted email addresses in contact list 120 associated with contact segment 124. Publisher 118 sends content 114 to the email addresses identified for contact segment 124. For example, publisher 118 sends email announcing the electric car seminar to contact segment 124.

Sending content 114 to contact segment 124 may generate a substantial lift in the number of positive responses 126. For example, assume publisher 118 wants to send emails announcing early bird specials for the upcoming seminar. The seminar may include ten different tracks, such as electric cars, environmental issues, renewable energy, etc. In the past, publisher 118 may have sent ten different emails for each separate track to everyone in contact list 120.

Publisher 118 may now only send the email regarding the electric car track to contacts identified in contact segment 124. The number of positive responses 126 registering for the electric car track of the seminar may substantially increase since content 114 is now directed to users interested in electric cars.

In another example, CCM 100 may provide local ad campaign or email segmentation. For example, CCM 100 may provide a “yes” or “no” as to whether a particular advertisement should be shown to a particular user. In this example, CCM 100 may use the hashed data without re-identification of users and the “yes/no” action recommendation may key off of a de-identified hash value.

CCM 100 may revitalize cold contacts in publisher contact list 120. CCM 100 can identify the users in contact list 120 that are currently accessing other third party content 112 and identify the topics associated with third party content 112. By monitoring accesses to third party content 112, CCM 100 may identify current user interests even though those interests may not align with the content currently provided by publisher 118. Publisher 118 might reengage the cold contacts by providing content 114 more aligned with the most relevant topics identified in third party content 112.

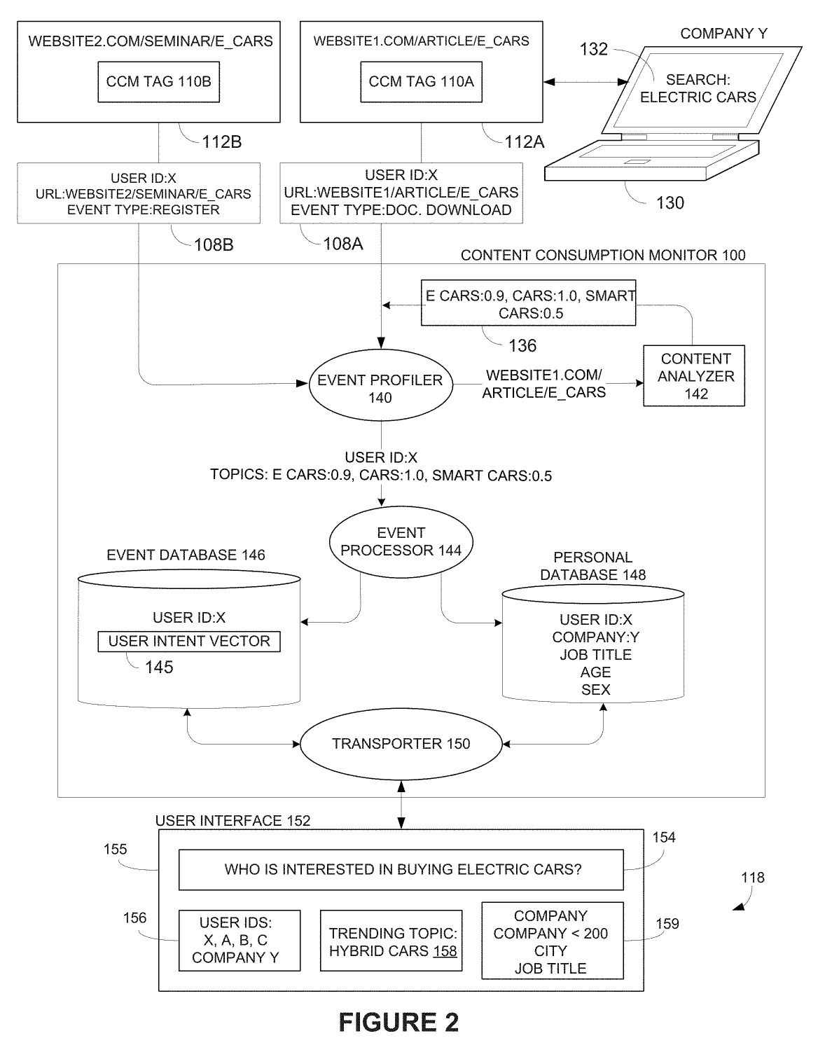

FIG. 2 is a diagram explaining the content consumption manager in more detail. A user may enter a search query 132 into a computer 130 via a search engine. The user may work for a company Y. For example, the user may have an associated email address USER@COMPANY_Y.com.

In response to search query 132, the search engine may display links to content 112A and 112B on website1 and website2, respectively. The user may click on the link to website1. Website1 may download a web page to computer 130 that includes a link to a white paper. Website1 may include one or more web pages with CCM tags 110A that capture different events during the web session between website1 and computer 130. Website1 or another website may have downloaded a cookie onto a web browser operating on computer 130. The cookie may comprise an identifier X, such as a unique alphanumeric set of characters associated with the web browser on computer 130.

During the web session with website1, the user of computer 130 may click on a link to white paper 112A. In response to the mouse click, CCM tag 110A may download an event 108A to CCM 100. Event 108A may identify the cookie identifier X loaded on the web browser of computer 130. In addition, or alternatively, CCM tag 110A may capture a user name and/or email address entered into one or more web page fields during the web session. CCM tag 110 hashes the email address and includes the hashed email address in event 108A. Any identifier associated with the user is referred to generally as user X or user ID.

CCM tag 110A also may include a link in event 108A to the white paper downloaded from website1 to computer 130. For example, CCM tag 110A may capture the universal resource locator (URL) for white paper 112A. CCM tag 110A also may include an event type identifier in event 108A that identifies an action or activity associated with content 112A. For example, CCM tag 110A may insert an event type identifier into event 108A that indicates the user downloaded an electric document.

CCM tag 110A also may identify the launching platform for accessing content 112B. For example, CCM tag 110B may identify a link www.searchengine.com to the search engine used for accessing website1.

An event profiler 140 in CCM 100 forwards the URL identified in event 108A to a content analyzer 142. Content analyzer 142 generates a set of topics 136 associated with or suggested by white paper 112A. For example, topics 136 may include electric cars, cars, smart cars, electric batteries, etc. Each topic 136 may have an associated relevancy score indicating the relevancy of the topic in white paper 112A. Content analyzers that identify topics in documents are known to those skilled in the art and are therefore not described in further detail.

Event profiler 140 forwards the user ID, topics 136, event type, and any other data from event 108A to event processor 144. Event processor 144 may store personal information captured in event 108A in a personal database 148. For example, during the web session with website1, the user may have entered an employer company name into a web page form field. CCM tag 110A may copy the employer company name into event 108A. Alternatively, CCM 100 may identify the company name from a domain name of the user email address.

Event processor 144 may store other demographic information from event 108A in personal database 148, such as user job title, age, sex, geographic location (postal address), etc. In one example, some of the information in personal database 148 is hashed, such as the user ID and or any other personally identifiable information. Other information in personal database 148 may be anonymous to any specific user, such as company name and job title.

Event processor 144 builds a user intent vector 145 from topic vectors 136. Event processor 144 continuously updates user intent vector 145 based on other received events 108. For example, the search engine may display a second link to website2 in response to search query 132. User X may click on the second link and website2 may download a web page to computer 130 announcing the seminar on electric cars.

The web page downloaded by website2 also may include a CCM tag 110B. User X may register for the seminar during the web session with website2. CCM tag 110B may generate a second event 108B that includes the user ID: X, a URL link to the web page announcing the seminar, and an event type indicating the user registered for the electric car seminar advertised on the web page.

CCM tag 110B sends event 108B to CCM 100. Content analyzer 142 generates a second set of topics 136. Event 108B may contain additional personal information associated with user X. Event processor 144 may add the additional personal information to personal database 148.

Event processor 144 updates user intent vector 145 based on the second set of topics 136 identified for event 108B. Event processor 144 may add new topics to user intent vector 145 or may change the relevancy scores for existing topics. For example, topics identified in both event 108A and 108B may be assigned higher relevancy scores. Event processor 144 also may adjust relevancy scores based on the associated event type identified in events 108.

Publisher 118 may submit a search query 154 to CCM 100 via a user interface 152 on a computer 155. For example, search query 154 may ask WHO IS INTERESTED IN BUYING ELECTRIC CARS? A transporter 150 in CCM 100 searches user intent vectors 145 for electric car topics with high relevancy scores. Transporter 150 may identify user intent vector 145 for user X. Transporter 150 identifies user X and other users A, B, and C interested in electric cars in search results 156.

As mentioned above, the user IDs may be hashed and CCM 100 may not know the actual identities of users X, A, B, and C. CCM 100 may provide a segment of hashed user IDs X, A, B, and C to publisher 118 in response to query 154.

Publisher 118 may have a contact list 120 of users (FIG. 1). Publisher 118 may hash email addresses in contact list 120 and compare the hashed identifiers with the encrypted or hashed user IDs X, A, B, and C. Publisher 118 identifies the unencrypted email address for matching user identifiers. Publisher 118 then sends information related to electric cars to the email addresses of the identified user segment. For example, publisher 118 may send emails containing white papers, advertisements, articles, announcements, seminar notifications, or the like, or any combination thereof.

CCM 100 may provide other information in response to search query 154. For example, event processor 144 may aggregate user intent vectors 145 for users employed by the same company Y into a company intent vector. The company intent vector for company Y may indicate a strong interest in electric cars. Accordingly, CCM 100 may identify company Y in search results 156. By aggregating user intent vectors 145, CCM 100 can identify the intent of a company or other category without disclosing any specific user personal information, e.g., without regarding a user's online browsing activity.

CCM 100 continuously receives events 108 for different third-party content. Event processor 144 may aggregate events 108 for a particular time period, such as for a current day, for the past week, or for the past 30 days. Event processor 144 then may identify trending topics 158 within that particular time period. For example, event processor 144 may identify the topics with the highest average relevancy values over the last 30 days.

Different filters 159 may be applied to the intent data stored in event database 146. For example, filters 159 may direct event processor 144 to identify users in a particular company Y that are interested in electric cars. In another example, filters 159 may direct event processor 144 to identify companies with less than 200 employees that are interested in electric cars.

Filters 159 also may direct event processor 144 to identify users with a particular job title that are interested in electric cars or identify users in a particular city that are interested in electric cars. CCM 100 may use any demographic information in personal database 148 for filtering query 154.

CCM 100 monitors content accessed from multiple different third-party websites. This allows CCM 100 to better identify the current intent for a wider variety of users, companies, or any other demographics. CCM 100 may use hashed and/or other anonymous identifiers to maintain user privacy. CCM 100 further maintains user anonymity by identifying the intent of generic user segments, such as companies, marketing groups, geographic locations, or any other user demographics.

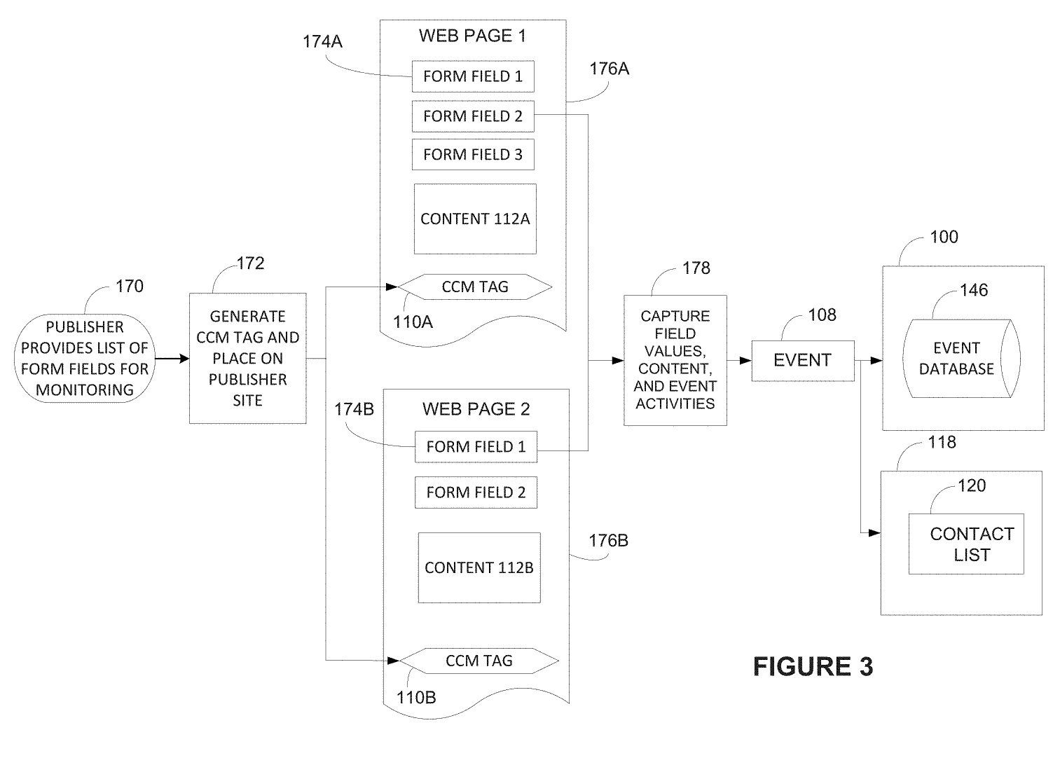

FIG. 3 depicts example operations performed by CCM tags. In operation 170, a publisher provides a list of form fields 174 for monitoring on web pages 176. In operation 172, CCM tags 110 are generated and loaded in web pages 176 on the publisher website. For example, CCM tag 110A is loaded onto a first web page 176A of the publisher website and a CCM tag 110B is loaded onto a second web page 176B of the publisher website. In one example, CCM tags 110 comprise JavaScript loaded into the web page document object model (DOM).

The publisher may download web pages 176, along with CCM tags 110, to user computers during web sessions. CCM tag 110A captures the data entered into some of form fields 174A and CCM tag 110B captures data entered into some of form fields 174B.

A user enters information into form fields 174A and 174B during the web session. For example, the user may enter an email address into one of form fields 174A during a user registration process. CCM tags 110 may capture the email address in operation 178, validate and hash the email address, and then send the hashed email address to CCM 100 in event 108.

CCM tags 100 may first confirm the email address includes a valid domain syntax and then use a hash algorithm to encode the valid email address string. CCM tags 110 also may capture other anonymous user identifiers, such as a cookie identifier. If no identifiers exist, CCM tag 110 may create a unique identifier.

CCM tags 110 may capture any information entered into fields 174. For example, CCM tags 110 also may capture user demographic data, such as company name, age, sex, postal address, etc. In one example, CCM tags 110 capture some the information for publisher contact list 120.

CCM tags 110 also may identify content 112 and associated event activities in operation 178. For example, CCM tag 110A may detect a user downloading a white paper 112A or registering for a seminar. CCM tag 110A captures the URL for white paper 112A and generates an event type identifier that identifies the event as a document download.

Depending on the application, CCM tag 110 in operation 178 sends the captured web session information in event 108 to publisher 118 or to CCM 100. For example, event 108 is sent to publisher 118 when CCM tag 110 is used for generating publisher contact list 120. Event 108 is sent to CCM 100 when CCM tag 110 is used for generating intent data.

CCM tags 110 may capture the web session information in response to the user leaving web page 176, existing one of form fields 174, selecting a submit icon, mousing out of one of form fields 174, mouse clicks, an off focus, or any other user action. Note again that CCM 100 might never receive personally identifiable information (PII) since any PII data in event 108 is hashed by CCM tag 110.

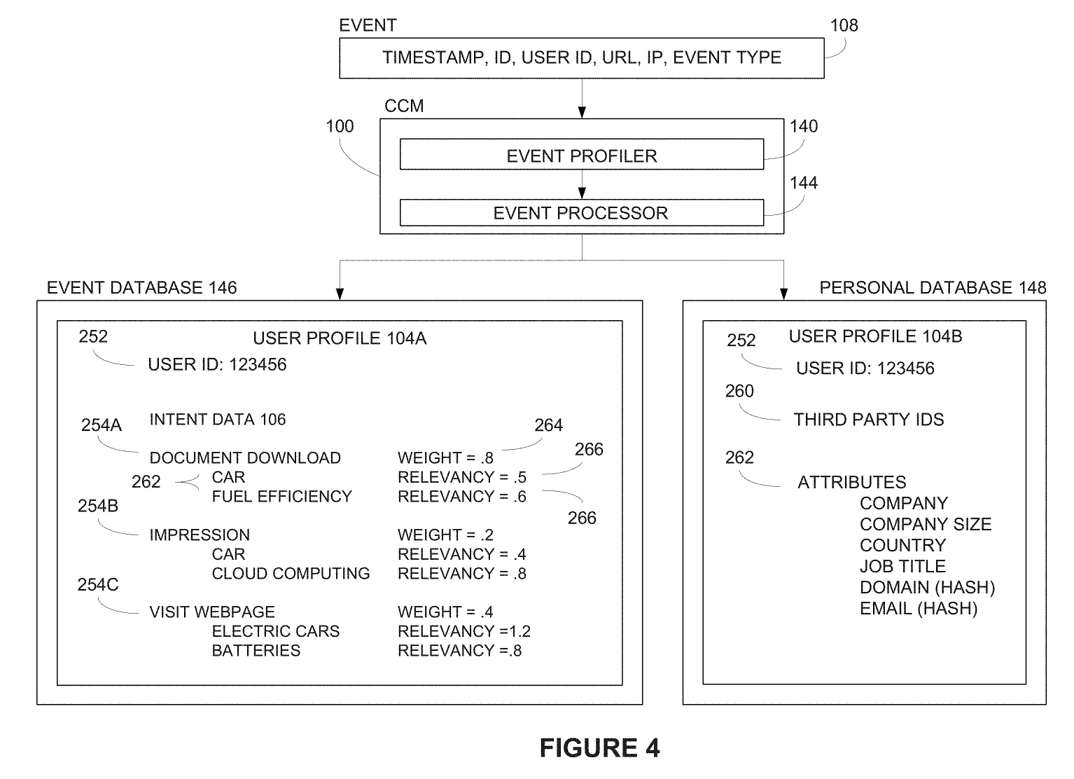

FIG. 4 is a diagram showing how the CCM generates intent data. A CCM tag may send a captured raw event 108 to CCM 100. For example, the CCM tag may send event 108 to CCM 100 in response to a user downloading a white paper. Event 108 may include a timestamp indicating when the white paper was downloaded, an identifier (ID) for event 108, a user ID associated with the user that downloaded the white paper, a URL for the downloaded white paper, and an IP address for the launching platform for the content. Event 108 also may include an event type indicating the user downloaded an electronic document.

Event profiler 140 and event processor 144 may generate intent data 106 from one or more events 108. Intent data 106 may be stored in a structured query language (SQL) database or non-SQL database. In one example, intent data 106 is stored in user profile 104A and includes a user ID 252 and associated event data 254.

Event data 254A is associated with a user downloading a white paper. Event profiler 140 identifies a car topic 262 and a fuel efficiency topic 262 in the white paper. Event profiler 140 may assign a 0.5 relevancy value to the car topic and assign a 0.6 relevancy value to the fuel efficiency topic.

Event processor 144 may assign a weight value 264 to event data 254A. Event processor 144 may assign larger a weight value 264 to more assertive events, such as downloading the white paper. Event processor 144 may assign a smaller weight value 264 to less assertive events, such as viewing a web page. Event processor 144 may assign other weight values 264 for viewing or downloading different types of media, such as downloading a text, video, audio, electronic books, on-line magazines and newspapers, etc.

CCM 100 may receive a second event 108 for a second piece of content accessed by the same user. CCM 100 generates and stores event data 254B for the second event 108 in user profile 104A. Event profiler 140 may identify a first car topic with a relevancy value of 0.4 and identify a second cloud computing topic with a relevancy value of 0.8 for the content associated with event data 254B. Event processor 144 may assign a weight value of 0.2 to event data 254B.

CCM 100 may receive a third event 108 for a third piece of content accessed by the same user. CCM 100 generates and stores event data 254C for the third event 108 in user profile 104A. Event profiler 140 identifies a first topic associated with electric cars with a relevancy value of 1.2 and identifies a second topic associated with batteries with a relevancy value of 0.8. Event processor 144 may assign a weight value of 0.4 to event data 254C.

Event data 254 and associated weighting values 264 may provide a better indicator of user interests/intent. For example, a user may complete forms on a publisher website indicating an interest in cloud computing. However, CCM 100 may receive events 108 for third party content accessed by the same user. Events 108 may indicate the user downloaded a whitepaper discussing electric cars and registered for a seminar related to electric cars.

CCM 100 generates intent data 106 based on received events 108. Relevancy values 266 in combination with weighting values 264 may indicate the user is highly interested in electric cars. Even though the user indicated an interest in cloud computing on the publisher website, CCM 100 determined from the third-party content that the user was actually more interested in electric cars.

CCM 100 may store other personal user information from events 108 in user profile 104B. For example, event processor 144 may store third party identifiers 260 and attributes 262 associated with user ID 252. Third party identifiers 260 may include user names or any other identifiers used by third parties for identifying user 252. Attributes 262 may include an employer company name, company size, country, job title, hashed domain name, and/or hashed email addresses associated with user ID 252. Attributes 262 may be combined from different events 108 received from different websites accessed by the user. CCM 100 also may obtain different demographic data in user profile 104 from third party data sources (whether sourced online or offline).

An aggregator may use user profile 104 to update and/or aggregate intent data for different segments, such as publisher contact lists, companies, job titles, etc. The aggregator also may create snapshots of intent data 106 for selected time periods.

Event processor 144 may generate intent data 106 for both known and unknown users. For example, the user may access a web page and enter an email address into a form field in the web page. A CCM tag captures and hashes the email address and associates the hashed email address with user ID 252.

The user may not enter an email address into a form field. Alternatively, the CCM tag may capture an anonymous cookie ID in event 108. Event processor 144 then associates the cookie ID with user identifier 252. The user may clear the cookie or access data on a different computer. Event processor 144 may generate a different user identifier 252 and new intent data 106 for the same user.

The cookie ID may be used to create a de-identified cookie data set. The de-identified cookie data set then may be integrated with ad platforms or used for identifying destinations for target advertising.

CCM 100 may separately analyze intent data 106 for the different anonymous user IDs. If the user ever fills out a form providing an email address, event processor then may re-associate the different intent data 106 with the same user identifier 252.

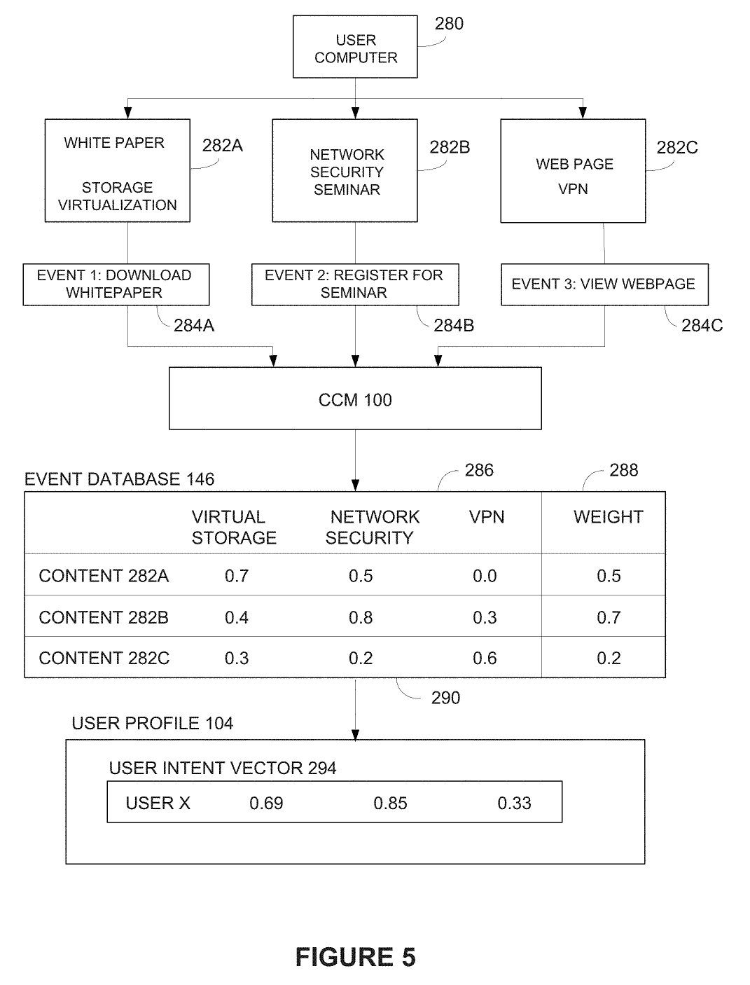

FIG. 5 depicts an example of how the CCM generates a user intent vector from the event data described above in FIG. 4. A user may use computer 280 to access different content 282. For example, the user may download a white paper 282A associated with storage virtualization, register for a network security seminar on a web page 282B, and view a web page article 282C related to virtual private networks (VPNs). Content 282A, 282B, and 282C may come from the same website or come from different websites.

The CCM tags discussed above capture three events 284A, 284B, and 284C associated with content 282A, 282B, and 282C, respectively. CCM 100 identifies topics 286 in content 282A, 282B, and/or 282C. Topics 286 include virtual storage, network security, and VPNs. CCM 100 assigns relevancy values 290 to topics 286 based on known algorithms. For example, relevancy values 290 may be assigned based on the number of times different associated keywords are identified in content 282.

CCM 100 assigns weight values 288 to content 282 based on the associated event activity. For example, CCM 100 assigns a relatively high weight value of 0.7 to a more assertive off-line activity, such as registering for the network security seminar. CCM 100 assigns a relatively low weight value of 0.2 to a more passive on-line activity, such as viewing the VPN web page.

CCM 100 generates a user intent vector 294 in user profile 104 based on the relevancy values 290. For example, CCM 100 may multiply relevancy values 290 by the associated weight values 288. CCM 100 then may sum together the weighted relevancy values for the same topics to generate user intent vector 294.

CCM 100 uses intent vector 294 to represent a user, represent content accessed by the user, represent user access activities associated with the content, and effectively represent the intent/interests of the user. In another embodiment, CCM 100 may assign each topic in user intent vector 294 a binary score of 1 or 0. CCM 100 may use other techniques for deriving user intent vector 294. For example, CCM 100 may weigh the relevancy values based on timestamps.

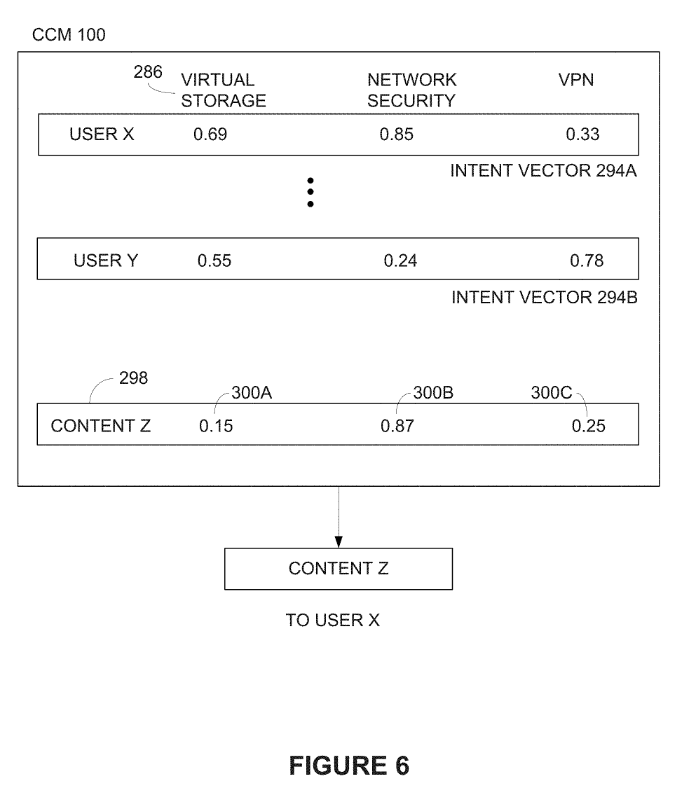

FIG. 6 depicts an example of how the CCM segments users. CCM 100 may generate user intent vectors 294A and 294B for two different users. A publisher may want to email content 298 to a segment of interested users. The publisher submits content 298 to CCM 100. CCM 100 identifies topics 286 and associated relevancy values 300 for content 298.

CCM 100 may use any variety of different algorithms to identify a segment of user intent vectors 294 associated with content 298. For example, relevancy value 300B indicates content 298 is primarily related to network security. CCM 100 may identify any user intent vectors 294 that include a network security topic with a relevancy value above a given threshold value.

In this example, assume the relevancy value threshold for the network security topic is 0.5. CCM 100 identifies user intent vector 294A as part of the segment of users satisfying the threshold value. Accordingly, CCM 100 sends the publisher of content 298 a contact segment that includes the user ID associated with user intent vector 294A. As mentioned above, the user ID may be a hashed email address, cookie ID, or some other encrypted or unencrypted identifier associated with the user.

In another example, CCM 100 calculates vector cross products between user intent vectors 294 and content 298. Any user intent vectors 294 that generate a cross product value above a given threshold value are identified by CCM 100 and sent to the publisher.

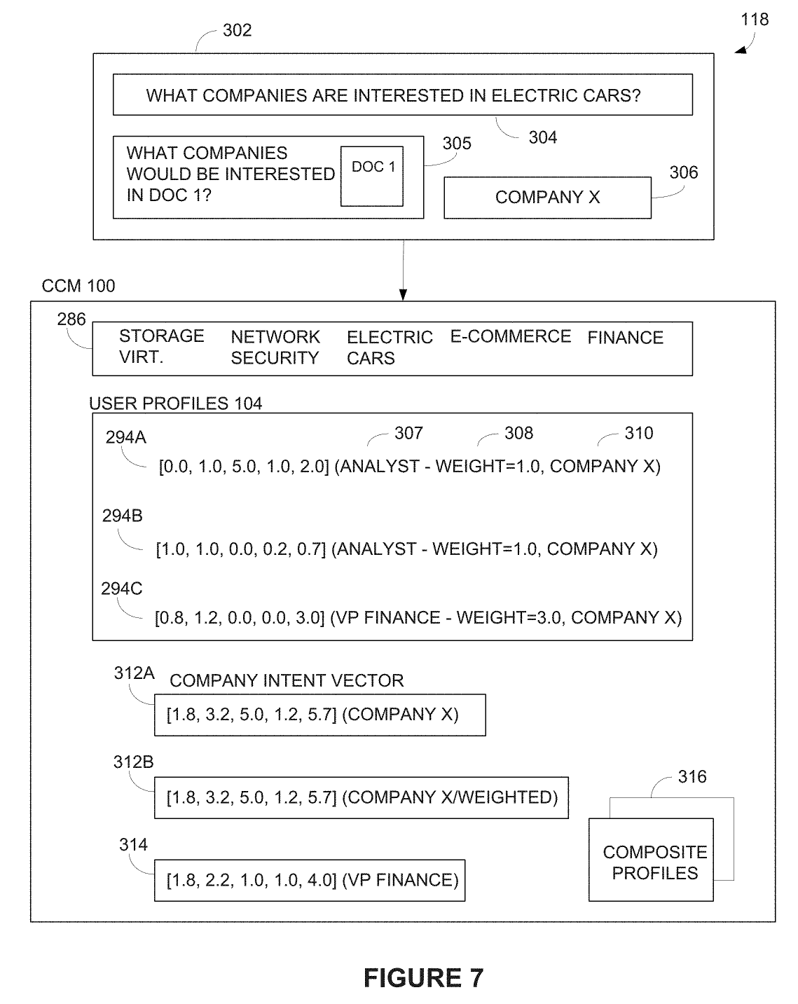

FIG. 7 depicts examples of how the CCM aggregates intent data. In this example, a publisher operating a computer 302 submits a search query 304 to CCM 100 asking what companies are interested in electric cars. In this example, CCM 100 associates five different topics 286 with user profiles 104. Topics 286 include storage virtualization, network security, electric cars, e-commerce, and finance.

CCM 100 generates user intent vectors 294 as described above in FIG. 6. User intent vectors 294 have associated personal information, such as a job title 307 and an employer company name 310. As explained above, users may provide personal information, such as employer name and job title in form fields when accessing a publisher or third-party website.

The CCM tags described above capture and send the job title and employer name information to CCM 100. CCM 100 stores the job title and employer information in the associated user profile 104.

CCM 100 searches user profiles 104 and identifies three user intent vectors 294A, 294B, and 294C associated with the same employer name 310. CCM 100 determines that user intent vectors 294A and 294B are associated with a same job title of analyst and user intent vector 294C is associated with a job title of VP of finance.

In response to, or prior to, search query 304, CCM 100 generates a company intent vector 312A for company X. CCM 100 may generate company intent vector 312A by summing up the topic relevancy values for all of the user intent vectors 294 associated with company X.

In response to search query 304, CCM 100 identifies any company intent vectors 312 that include an electric car topic 286 with a relevancy value greater than a given threshold. For example, CCM 100 may identify any companies with relevancy values greater than 4.0. In this example, CCM 100 identifies company X in search results 306.

In one example, intent is identified for a company at a particular zip code, such as zip code 11201. CCM 100 may take customer supplied offline data, such as from a Customer Relationship Management (CRM) database, and identify the users that match the company and zip code 11201 to create a segment.

In another example, publisher 118 may enter a query 305 asking which companies are interested in a document (DOC 1) related to electric cars. Computer 302 submits query 305 and DOC 1 to CCM 100. CCM 100 generates a topic vector for DOC 1 and compares the DOC 1 topic vector with all known company intent vectors 312A.

CCM 100 may identify an electric car topic in the DOC 1 with high relevancy value and identify company intent vectors 312 with an electric car relevancy value above a given threshold. In another example, CCM 100 may perform a vector cross product between the DOC 1 topics and different company intent vectors 312. CCM 100 may identify the names of any companies with vector cross product values above a given threshold value and display the identified company names in search results 306.

CCM 100 may assign weight values 308 for different job titles. For example, an analyst may be assigned a weight value of 1.0 and a vice president (VP) may be assigned a weight value of 3.0. Weight values 308 may reflect purchasing authority associated with job titles 307. For example, a VP of finance may have higher authority for purchasing electric cars than an analyst. Weight values 308 may vary based on the relevance of the job title to the particular topic. For example, CCM 100 may assign an analyst a higher weight value 308 for research topics.

CCM 100 may generate a weighted company intent vector 312B based on weighting values 308. For example, CCM 100 may multiply the relevancy values for user intent vectors 294A and 294B by weighting value 1.0 and multiply the relevancy values for user intent vector 294C by weighting value 3.0. The weighted topic relevancy values for user intent vectors 294A, 294B, and 294C are then summed together to generate weighted company intent vector 312B.

CCM 100 may aggregate together intent vectors for other categories, such as job title. For example, CCM 100 may aggregate together all the user intent vectors 294 with VP of finance job titles into a VP of finance intent vector 314. Intent vector 314 identifies the topics of interest to VPs of finance.

CCM 100 also may perform searches based on job title or any other category. For example, publisher 118 may enter a query LIST VPs OF FINANCE INTERESTED IN ELECTRIC CARS? The CCM 100 identifies all of the user intent vectors 294 with associated VP finance job titles 307. CCM 100 then segments the group of user intent vectors 294 with electric car topic relevancy values above a given threshold value.

CCM 100 may generate composite profiles 316. Composite profiles 316 may contain specific information provided by a particular publisher or entity. For example, a first publisher may identify a user as VP of finance and a second publisher may identify the same user as VP of engineering. Composite profiles 316 may include other publisher provided information, such as company size, company location, company domain.

CCM 100 may use a first composite profile 316 when providing user segmentation for the first publisher. The first composite profile 316 may identify the user job title as VP of finance. CCM 100 may use a second composite profile 316 when providing user segmentation for the second publisher. The second composite profile 316 may identify the job title for the same user as VP of engineering. Composite profiles 316 are used in conjunction with user profiles 104 derived from other third-party content.

In yet another example, CCM 100 may segment users based on event type. For example, CCM 100 may identify all the users that downloaded a particular article, or identify all of the users from a particular company that registered for a particular seminar.

### Consumption Scoring

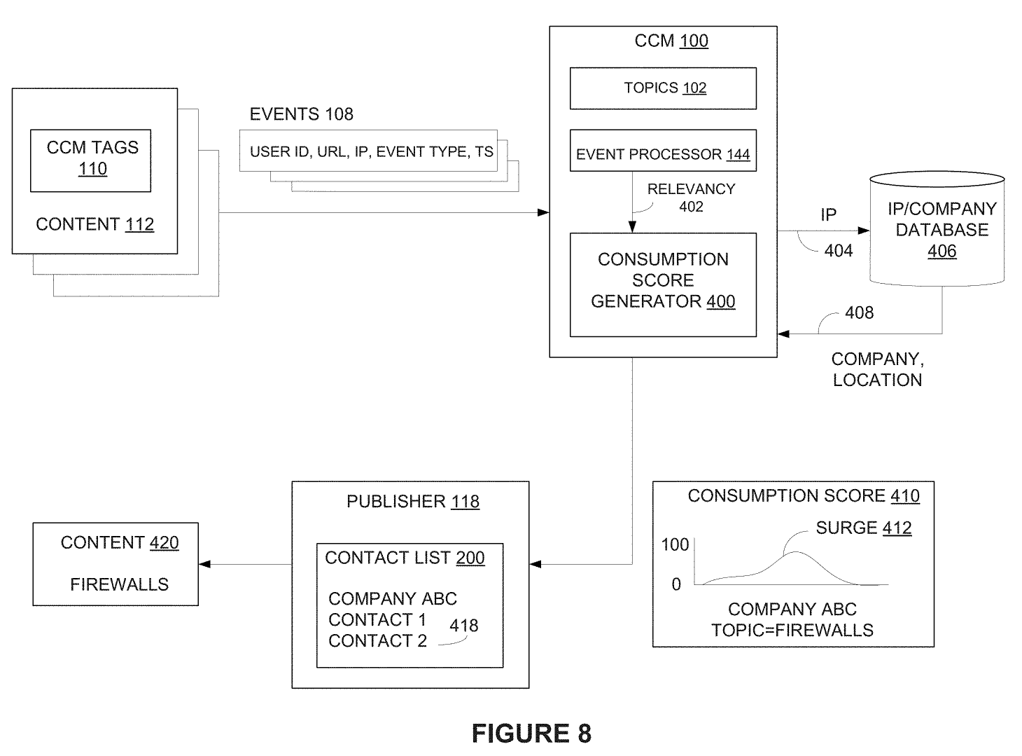

FIG. 8 depicts an example consumption score generator used in CCM 100. As explained above, CCM 100 may receive multiple events 108 associated with different content 112. For example, users may access web browsers, or any other application, to view content 112 on different websites. Content 112 may include any webpage, document, article, advertisement, or any other information viewable or audible by a user. For example, content 112 may include a webpage article or a document related to network firewalls.

CCM tag 110 may capture events 108 identifying content 112 accessed by a user during the web or application session. For example, events 108 may include a user identifier (USER ID), URL, IP address, event type, and time stamp (TS).

The user identifier may be a unique identifier CCM tag 110 generates for a specific user on a specific browser. The URL may be a link to content 112 accessed by the user during the web session. The IP address may be for a network device used by the user to access the Internet and content 112. As explained above, the event type may identify an action or activity associated with content 112. For example, the event type may indicate the user downloaded an electric document or displayed a webpage. The timestamp (TS) may identify a day and time the user accessed content 112.

Consumption score generator (CSG) 400 may access a IP/company database 406 to identify a company/entity and location 408 associated with IP address 404 in event 108. For example, existing services may provide databases 406 that identify the company and company address associated with IP addresses. The IP address and/or associated company or entity may be referred to generally as a domain. CSG 400 may generate metrics from events 108 for the different companies 408 identified in database 406.

In another example, CCM tags 110 may include domain names in events 108. For example, a user may enter an email address into a web page field during a web session. CCM 100 may hash the email address or strip out the email domain address. CCM 100 may use the domain name to identify a particular company and location 408 from database 406.

As also described above, event processor 144 may generate relevancy scores 402 that indicate the relevancy of content 112 with different topics 102. For example, content 112 may include multiple words associate with topics 102. Event processor 144 may calculate relevancy scores 402 for content 112 based on the number and position words associated with a selected topic.

CSG 400 may calculate metrics from events 108 for particular companies 408. For example, CSG 400 may identify a group of events 108 for a current week that include the same IP address 404 associated with a same company and company location 408. CSG 400 may calculate a consumption score 410 for company 408 based on an average relevancy score 402 for the group of events 108. CSG 400 also may adjust the consumption score 410 based on the number of events 108 and the number of unique users generating the events 108.

CSG 400 may generate consumption scores 410 for company 408 for a series of time periods. CSG 400 may identify a surge 412 in consumption scores 410 based on changes in consumption scores 410 over a series of time periods. For example, CSG 400 may identify surge 412 based on changes in content relevancy, number of unique users, and number of events over several weeks. It has been discovered that surge 412 may correspond with a unique period when companies have heightened interest in a particular topic and are more likely to engage in direct solicitations related to that topic.

CCM 100 may send consumption scores 410 and/or any surge indicators 412 to publisher 118. Publisher 118 may store a contact list 200 that includes contacts 418 for company ABC. For example, contact list 200 may include email addresses or phone number for employees of company ABC. Publisher 118 may obtain contact list 200 from any source such as from a customer relationship management (CRM) system, commercial contact lists, personal contacts, third parties lead services, retail outlets, promotions or points of sale, or the like or any combination thereof.

In one example, CCM 100 may send weekly consumption scores 410 to publisher 118. In another example, publisher 118 may have CCM 100 only send surge notices 412 for companies on list 200 surging for particular topics 102.

Publisher 118 may send content 420 related to surge topics to contacts 418. For example, publisher 118 may send email advertisements, literature, or banner ads related to a firewall to contacts 418. Alternatively, publisher 118 may call or send direct mailings regarding firewalls to contacts 418. Since CCM 100 identified surge 412 for a firewall topic at company ABC, contacts 418 at company ABC are more likely to be interested in reading and/or responding to content 420 related to firewalls. Thus, content 420 is more likely to have a higher impact and conversion rate when sent to contacts 418 of company ABC during surge 412.

In another example, publisher 118 may sell a particular product, such as firewalls. Publisher 118 may have a list of contacts 418 at company ABC known to be involved with purchasing firewall equipment. For example, contacts 418 may include the chief technology officer (CTO) and information technology (IT) manager at company ABC. CCM 100 may send publisher 118 a notification whenever a surge 412 is detected for firewalls at company ABC. Publisher 118 then may automatically send content 420 to specific contacts 418 at company ABC with job titles most likely to be interested in firewalls.

CCM 100 also may use consumption scores 410 for advertising verification. For example, CCM 100 may compare consumption scores 410 with advertising content 420 sent to companies or individuals. Advertising content 420 with a particular topic sent to companies or individuals with a high consumption score or surge for that same topic may receive higher advertising rates.

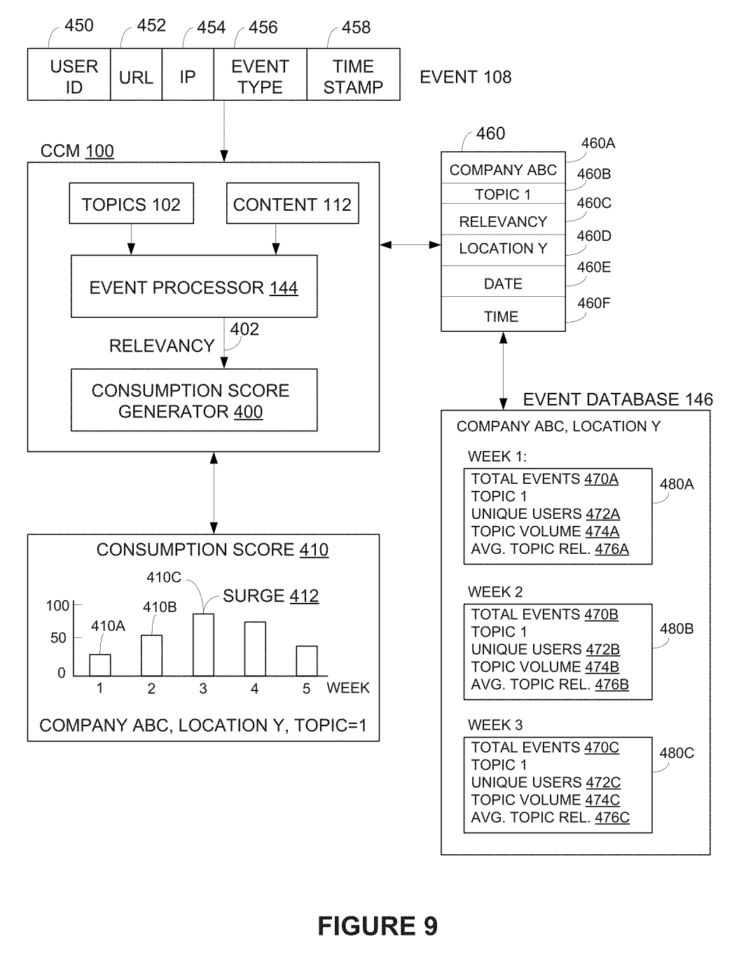

FIG. 9 shows in more detail how CCM 100 generates consumption scores 410. CCM 100 may receive millions of events from millions of different users associated with thousands of different domains every day. CCM 100 may accumulate the events 108 for different time periods, such as for each week. Week time periods are just one example and CCM 100 may accumulate events 108 for any selectable time period. CCM 100 also may store a set of topics 102 for any selectable subject matter. CCM 100 also may dynamically generate some of topics 102 based on the content identified in events 108 as described above.

Events 108 as mentioned above may include a user ID 450, URL 452, IP address 454, event type 456, and time stamp 458. Event processor 144 may identify content 112 located at URL 542 and select one of topics 102 for comparing with content 112. Event processor 144 may generate an associated relevancy score 402 indicating the relevancy of content 112 to selected topic 102. Relevancy score 402 may alternatively be referred to as a topic score.

CSG 400 may generate consumption data 460 from events 108. For example, CSG 400 may identify a company 460A associated with IP address 454. CSG 400 also may calculate a relevancy score 460C between content 112 and the selected topic 460B. CSG 400 also may identify a location 460D for with company 460A and identify a date 460E and time 460F when event 108 was detected.

CSG 400 may generate consumption metrics 480 from consumption data 460. For example, CSG 400 may calculate a total number of events 470A associated with company 460A (company ABC) and location 460D (location Y) for all topics during a first time period, such as for a first week. CSG 400 also may calculate the number of unique users 472A generating the events 108 associated with company ABC and topic 460B for the first week. CSG 400 may calculate for the first week a total number of events generated by company ABC for topic 460B (topic volume 474A). CSG 400 also may calculate an average topic relevancy 476A for the content accessed by company ABC and associated with topic 460B. CSG 400 may generate consumption metrics 480A-480C for sequential time periods, such as for three consecutive weeks.

CSG 400 may generate consumption scores 410 based on consumption metrics 480A-480C. For example, CSG 400 may generate a first consumption score 410A for week 1 and generate a second consumption score 410B for week 2 based in part on changes between consumption metrics 480A for week 1 and consumption metrics 480B for week 2. CSG 400 may generate a third consumption score 410C for week 3 based in part on changes between consumption metrics 480A, 480B, and 480C for weeks 1, 2, and 3, respectively. In one example, any consumption score 410 above as threshold value is identified as a surge 412.

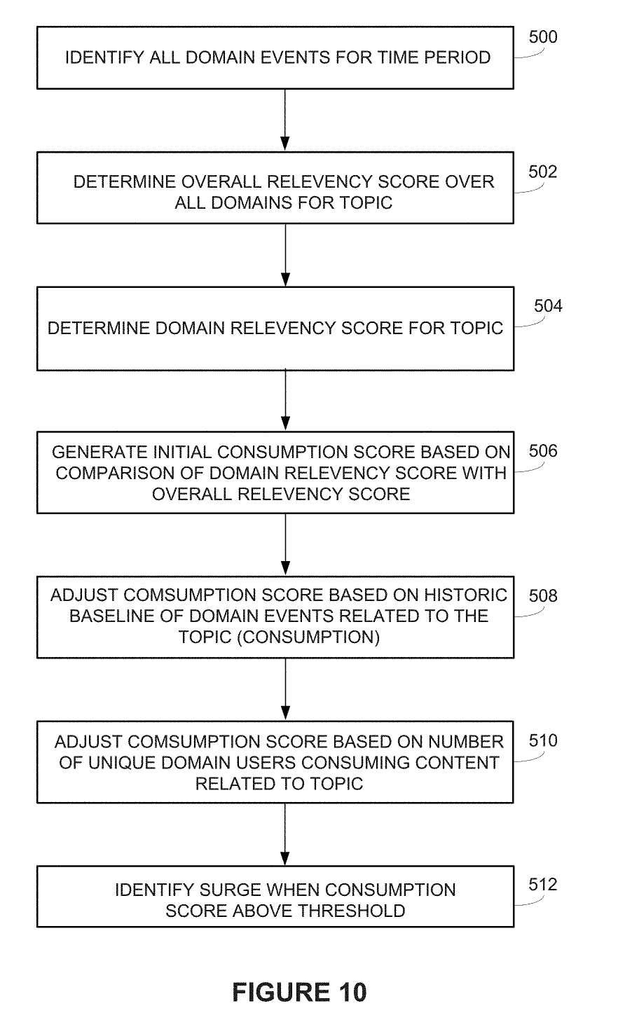

FIG. 10 depicts a process for identifying a surge in consumption scores. In operation 500, the CCM may identify all domain events for a given time period. For example, for a current week the CCM may accumulate all of the events for every IP address (domain) associated with every topic.

The CCM may use thresholds to select which domains to generate consumption scores. For example, for the current week the CCM may count the total number of events for a particular domain (domain level event count (DEC)) and count the total number of events for the domain at a particular location (metro level event count (DMEC)).

The CCM may calculate the consumption score for domains with a number of events more than a threshold (DEC>threshold). The threshold can vary based on the number of domains and the number of events. The CCM may use the second DMEC threshold to determine when to generate separate consumption scores for different domain locations. For example, the CCM may separate subgroups of company ABC events for the cities of Atlanta, New York, and Los Angeles that have each a number events DMEC above the second threshold.

In operation 502, the CCM may determine an overall relevancy score for all selected domains for each of the topics. For example, the CCM for the current week may calculate an overall average relevancy score for all domain events associated with the firewall topic.

In operation 504, the CCM may determine a relevancy score for a specific domain. For example, the CCM may identify a group of events having a same IP address associated with company ABC. The CCM may calculate an average domain relevancy score for the company ABC events associated with the firewall topic.

In operation 506, the CCM may generate an initial consumption score based on a comparison of the domain relevancy score with the overall relevancy score. For example, the CCM may assign an initial low consumption score when the domain relevancy score is a certain amount less than the overall relevancy score. The CCM may assign an initial medium consumption score larger than the low consumption score when the domain relevancy score is around the same value as the overall relevancy score. The CCM may assign an initial high consumption score larger than the medium consumption score when the domain relevancy score is a certain amount greater than the overall relevancy score. This is just one example, and the CCM may use any other type of comparison to determine the initial consumption scores for a domain/topic.

In operation 508, the CCM may adjust the consumption score based on a historic baseline of domain events related to the topic. This is alternatively referred to as consumption. For example, the CCM may calculate the number of domain events for company ABC associated with the firewall topic for several previous weeks.

The CCM may reduce the current week consumption score based on changes in the number of domain events over the previous weeks. For example, the CCM may reduce the initial consumption score when the number of domain events fall in the current week and may not reduce the initial consumption score when the number of domain events rises in the current week.

In operation 510, the CCM may further adjust the consumption score based on the number of unique users consuming content associated with the topic. For example, the CCM for the current week may count the number of unique user IDs (unique users) for company ABC events associated with firewalls. The CCM may not reduce the initial consumption score when the number of unique users for firewall events increases from the prior week and may reduce the initial consumption score when the number of unique users drops from the previous week.

In operation 512, the CCM may identify surges based on the adjusted weekly consumption score. For example, the CCM may identify a surge when the adjusted consumption score is above a threshold.

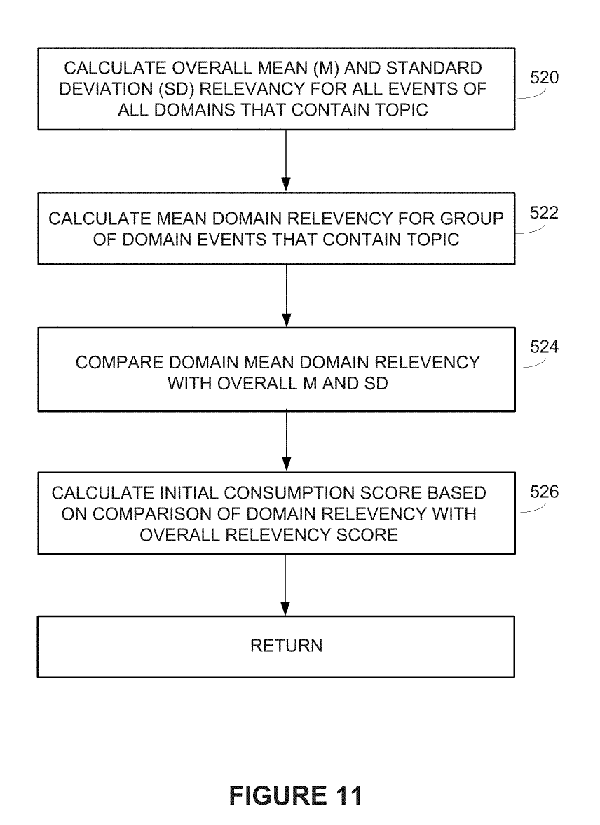

FIG. 11 depicts in more detail the process for generating an initial consumption score. It should be understood this is just one example scheme and a variety of other schemes also may be used.

In operation 520, the CCM may calculate an arithmetic mean (M) and standard deviation (SD) for each topic over all domains. The CCM may calculate M and SD either for all events for all domains that contain the topic, or alternatively for some representative (big enough) subset of the events that contain the topic. The CCM may calculate the overall mean and standard deviation as follows:

$$Mean \text{:} M = \frac{1}{n} * {\sum }_{1}^{n} {x}_{i}$$

$$Standard deviation \text{:} SD = \sqrt{\frac{1}{n - 1}} {\sum }_{1}^{n} {( {x}_{i} - M )}^{2}$$

Where xᵢ is a topic relevancy and n is a total number of events.

In operation 522, the CCM may calculate a mean (average) domain relevancy for each group of domain and/or domain/metro events for each topic. For example, for the past week the CCM may calculate the average relevancy for company ABC events for firewalls.

In operation 524, the CCM may compare the domain mean relevancy with the overall mean (M) relevancy and over standard deviation (SD) relevancy for all domains. For example, the CMM may assign three different levels to the domain mean relevancy (DMR).

Low: DMR<M−0.5*SD ˜33% of all values

Medium: M−0.5*SD<DMR<M+0.5*SD ˜33% of all values

High: DMR>M+0.5*SD ˜33% of all values

In operation 526, the CCM may calculate an initial consumption score for the domain/topic based on the above relevancy levels. For example, for the current week the CCM may assign one of the following initial consumption scores to the company ABC firewall topic. Again, this just one example of how the CCM may assign an initial consumption score to a domain/topic.

Relevancy=High: initial consumption score=100

Relevancy=Medium: Initial consumption score=70

Relevancy=Low: Initial consumption score 40.

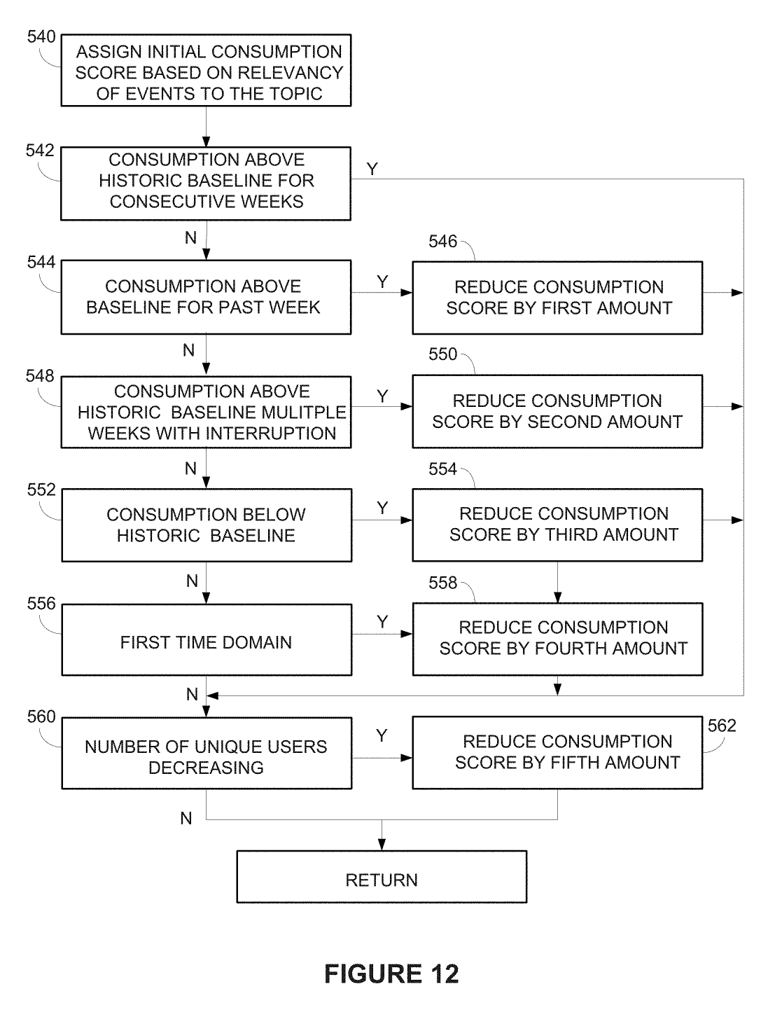

FIG. 12 depicts one example of how the CCM may adjust the initial consumption score. These are also just examples and the CCM may use other schemes for calculating a final consumption score. In operation 540, the CCM may assign an initial consumption score to the domain/location/topic as described above in FIG. 11.

The CCM may calculate a number of events for domain/location/topic for a current week. The number of events is alternatively referred to as consumption. The CCM also may calculate the number of domain/location/topic events for previous weeks and adjust the initial consumption score based on the comparison of current week consumption with consumption for previous weeks.

In operation 542, the CCM may determine if consumption for the current week is above historic baseline consumption for previous consecutive weeks. For example, the CCM may determine is the number of domain/location/topic events for the current week is higher than an average number of domain/location/topic events for at least the previous two weeks. If so, the CCM may not reduce the initial consumption value derived in FIG. 11.

If the current consumption is not higher than the average consumption in operation 542, the CCM in operation 544 may determine if the current consumption is above a historic baseline for the previous week. For example, the CCM may determine if the number of domain/location/topic events for the current week is higher than the average number of domain/location/topic events for the previous week. If so, the CCM in operation 546 may reduce the initial consumption score by a first amount.

If the current consumption is not above than the previous week consumption in operation 544, the CCM in operation 548 may determine if the current consumption is above the historic consumption baseline but with interruption. For example, the CCM may determine if the number of domain/location/topic events has fallen and then risen over recent weeks. If so, the CCM in operation 550 may reduce the initial consumption score by a second amount.

If the current consumption is not above than the historic interrupted baseline in operation 548, the CCM in operation 552 may determine if the consumption is below the historic consumption baseline. For example, the CCM may determine if the current number of domain/location/topic events is lower than the previous week. If so, the CCM in operation 554 may reduce the initial consumption score by a third amount.

If the current consumption is above the historic base line in operation 552, the CCM in operation 556 may determine if the consumption is for a first time domain. For example, the CCM may determine the consumption score is being calculated for a new company or for a company that did not previously have enough events to qualify for calculating a consumption score. If so, the CCM in operation 558 may reduce the initial consumption score by a fourth amount.

In one example, the CCM may reduce the initial consumption score by the following amounts. This of course is just an example and the CCM may use any values and factors to adjust the consumption score.

Consumption above historic baseline consecutive weeks (operation 542).—0

Consumption above historic baseline past week (operation 544).—20 (first amount).

Consumption above historic baseline for multiple weeks with interruption (operation 548)—30 (second amount).

Consumption below historic baseline (operation 552).—40 (third amount).

First time domain (domain/metro) observed (operation 556).—30 (fourth amount).

As explained above, the CCM also may adjust the initial consumption score based on the number of unique users. The CCM tags 110 in FIG. 8 may include cookies placed in web browsers that have unique identifiers. The cookies may assign the unique identifiers to the events captured on the web browser. Therefore, each unique identifier may generally represent a web browser for a unique user. The CCM may identify the number of unique identifiers for the domain/location/topic as the number of unique users. The number of unique users may provide an indication of the number of different domain users interested in the topic.

In operation 560, the CCM may compare the number of unique users for the domain/location/topic for the current week with the number of unique users for the previous week. The CCM may not reduce the consumption score if the number of unique users increases over the previous week. When the number of unique users decrease, the CCM in operation 562 may further reduce the consumption score by a fifth amount. For example, the CCM may reduce the consumption score by 10.

The CCM may normalize the consumption score for slower event days, such as weekends. Again, the CCM may use different time periods for generating the consumption scores, such as each month, week, day, hour, etc. The consumption scores above a threshold are identified as a surge or spike and may represent a velocity or acceleration in the interest of a company or individual in a particular topic. The surge may indicate the company or individual is more likely to engage with a publisher who presents content similar to the surge topic.

### Consumption DNA

One advantage of domain based surge detection is that a surge can be identified for a company without using personally identifiable information (PII) of the company employees. The CCM derives the surge data based on a company IP address without using PII associated with the users generating the events.

In another example, the user may provide PII information during web sessions. For example, the user may agree to enter their email address into a form prior to accessing content. As described above, the CCM may hash the PII information and include the encrypted PII information either with company consumption scores or with individual consumption scores.

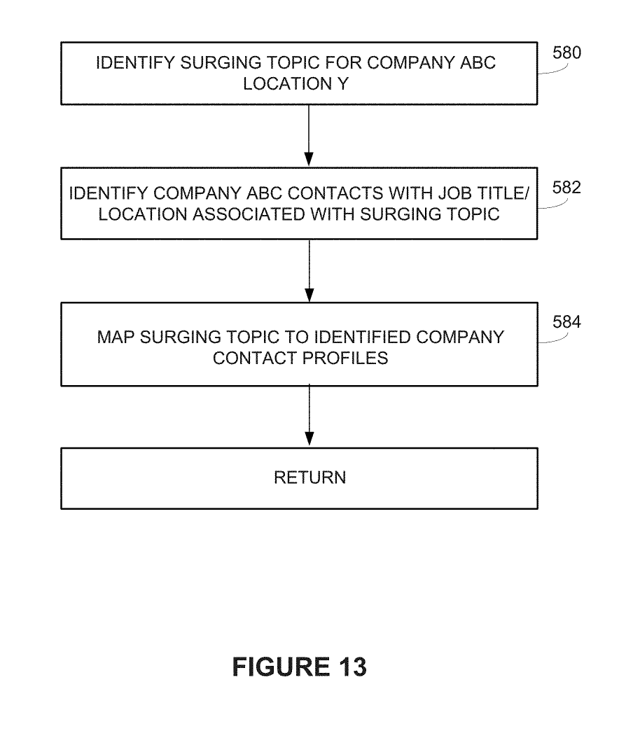

FIG. 13 shows one example process for mapping domain consumption data to individuals. In operation 580, the CCM may identify a surging topic for company ABC at location Y as described above. For example, the CCM may identify a surge for company ABC in New York for firewalls.

In operation 582, the CCM may identify users associated with company ABC. As mentioned above, some employees at company ABC may have entered personal contact information, including their office location and/or job titles into fields of web pages during events 108. In another example, a publisher or other party may obtain contact information for employees of company ABC from CRM customer profiles or third-party lists.

Either way, the CCM or publisher may obtain a list of employees/users associated with company ABC at location Y. The list also may include job titles and locations for some of the employees/users. The CCM or publisher may compare the surge topic with the employee job titles. For example, the CCM or publisher may determine that the surging firewall topic is mostly relevant to users with a job title such as engineer, chief technical officer (CTO), or information technology (IT).

In operation 584, the CCM or publisher maps the surging firewall topic to profiles of the identified employees of company ABC. In another example, the CCM or publisher may not be as discretionary and map the firewall surge to any user associated with company ABC. The CCM or publisher then may direct content associated with the surging topic to the identified users. For example, the publisher may direct banner ads or emails for firewall seminars, products, and/or services to the identified users.

Consumption data identified for individual users is alternatively referred to as Dino DNA and the general domain consumption data is alternatively referred to as frog DNA. Associating domain consumption and surge data with individual users associated with the domain may increase conversion rates by providing more direct contact to users more likely interested in the topic.

### Intent Measurement

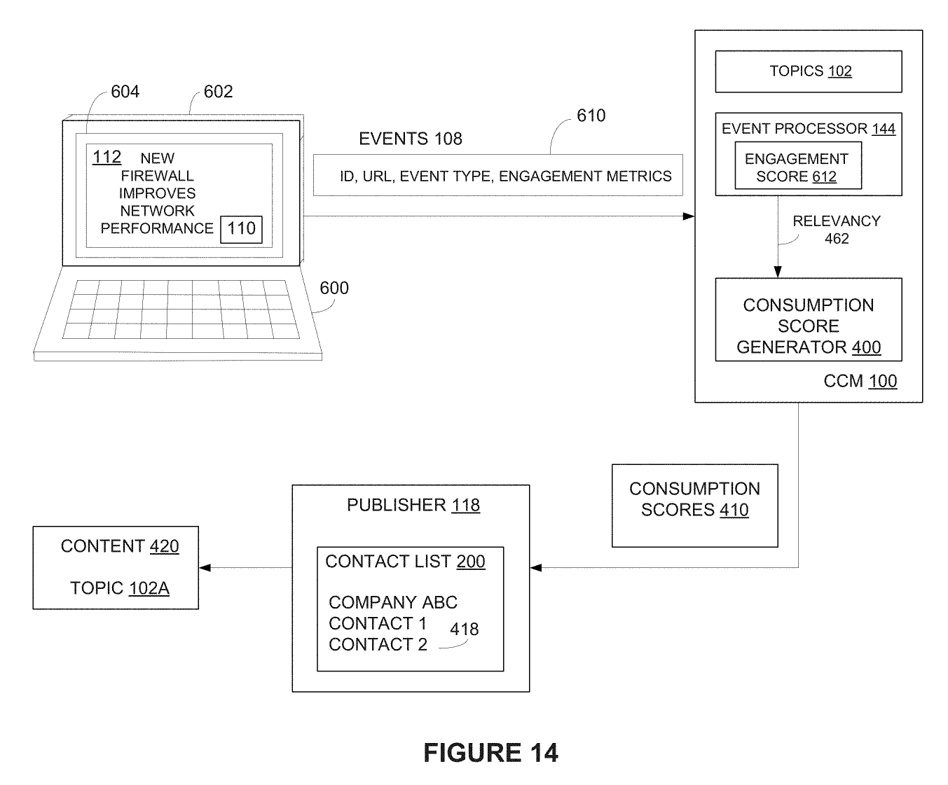

FIG. 14 depicts how CCM 100 may calculate consumption scores based on user engagement. A computer 600 may comprise a laptop, smart phone, tablet or any other device for accessing content 112. In this example, a user may open a web browser 604 on a screen 602 of computer 600. CCM tag 110 may operate within web browser 604 and monitor user web sessions. As explained above, CCM tag 110 may generate events 108 for the web session that include an identifier (ID), a URL for content 112, and an event type that identifies an action or activity associated with content 112. For example, CCM tag 110 may add an event type identifier into event 108 indicating the user downloaded an electric document.

In one example, CCM tag 110 also may generate a set of impressions, which is alternatively referred to as engagement metrics 610, indicating actions taken by the user while viewing content 112. For example, engagement metrics 610 may indicate how long the user dwelled on content 112 and/or how the user scrolled through content 112. Engagement metrics 610 may indicate a level of engagement or interest the user has in content 112. For example, the user may spend more time on the web page and scroll through web page at a slower speed when the user is more interested in the content 112.

CCM 100 may calculate an engagement score 612 for content 112 based on engagement metrics 610. CCM 100 may use engagement score 612 to adjust a relevancy score 402 for content 112. For example, CCM 100 may calculate a larger engagement score 612 when the user spends a larger amount of time carefully paging through content 112. CCM 100 then may increase relevancy score 402 of content 112 based on the larger engagement score 612. CSG 400 may adjust consumption scores 410 based on the increased relevancy 402 to more accurately identify domain surge topics. For example, a larger engagement score 612 may produce a larger relevancy 402 that produces a larger consumption score 410.

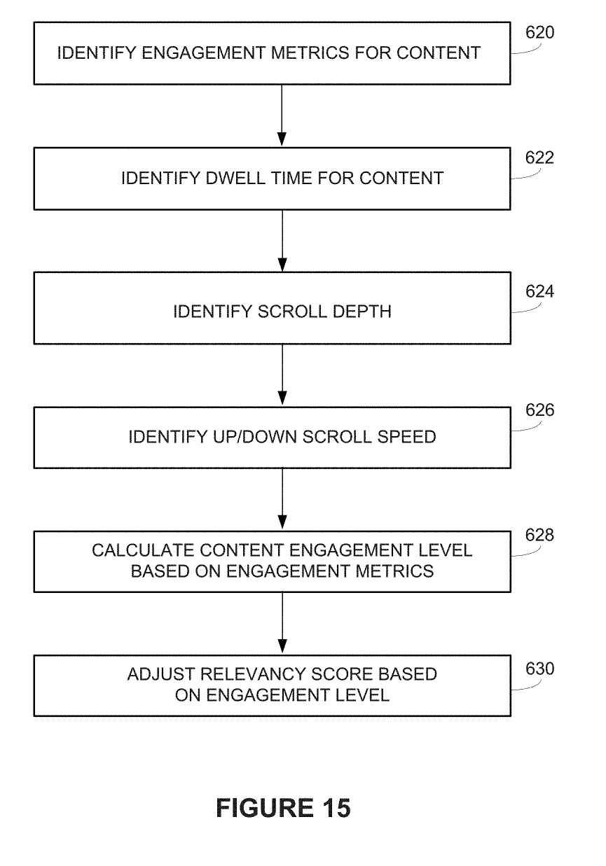

FIG. 15 depicts an example process for calculating the engagement score for content. In operation 620, the CCM may receive events that include content engagement metrics. For example, the engagement metrics may indicate any user interaction with content including tab selections that switch to different pages, page movements, mouse page scrolls, mouse clicks, mouse movements, scroll bar page scrolls, keyboard page movements, touch screen page scrolls, or any other content movement or content display indicator.

In operation 622, the CCM may identify the content dwell time. The dwell time may indicate how long the user actively views a page of content. In one example, tag 110 may stop a dwell time counter when the user changes page tabs or becomes inactive on a page. Tag 110 may start the dwell time counter again when the user starts scrolling with a mouse or starts tabbing.

In operation 624, the CCM may identify from the events a scroll depth for the content. For example, the CCM may determine how much of a page the user scrolled through or reviewed. In one example, the CCM tag or CCM may convert a pixel count on the screen into a percentage of the page.

In operation 626, the CCM may identify an up/down scroll speed. For example, dragging a scroll bar may correspond with a fast scroll speed and indicate the user has less interest in the content. Using a mouse wheel to scroll through content may correspond with a slower scroll speed and indicate the user is more interested in the content.

The CCM may assign higher values to engagement metrics that indicate a higher user interest and assign lower values to engagement metrics that indicate lower user interest. For example, the CCM may assign a larger value in operation 622 when the user spends more time actively dwelling on a page and may assign a smaller value when the user spends less time actively dwelling on a page.

In operation 628, the CCM may calculate the content engagement score based on the values derived in operations 622-628. For example, the CCM may add together and normalize the different values derived in operations 622-628.

In operation 630, the CCM may adjust content relevancy values described above in FIGS. 1-7 based on the content engagement score. For example, the CCM may increase the relevancy value when the content has a high engagement score and decrease the relevancy for a lower engagement score.

CCM 100 or CCM tag 110 in FIG. 14 may adjust the values assigned in operations 622-626 based on the type of device 600 used for viewing the content. For example, the dwell times, scroll depths, and scroll speeds, may vary between smart phone, tablets, laptops and desktop computers. CCM 100 or tag 110 may normalize or scale the engagement metric values so different devices provide similar relative user engagement results.

### Website Classification

It may be difficult to identify company purchasing intent based on brief user visits to a webpage that contains little content. However, a pattern of users visiting multiple vendor sites associated with the same topic during the same time period may identify a more significant interest signal. A site classifier may adjust relevancy scores based on different website classifications and produce surge signals that better indicate a company interest in purchasing a particular product or service.

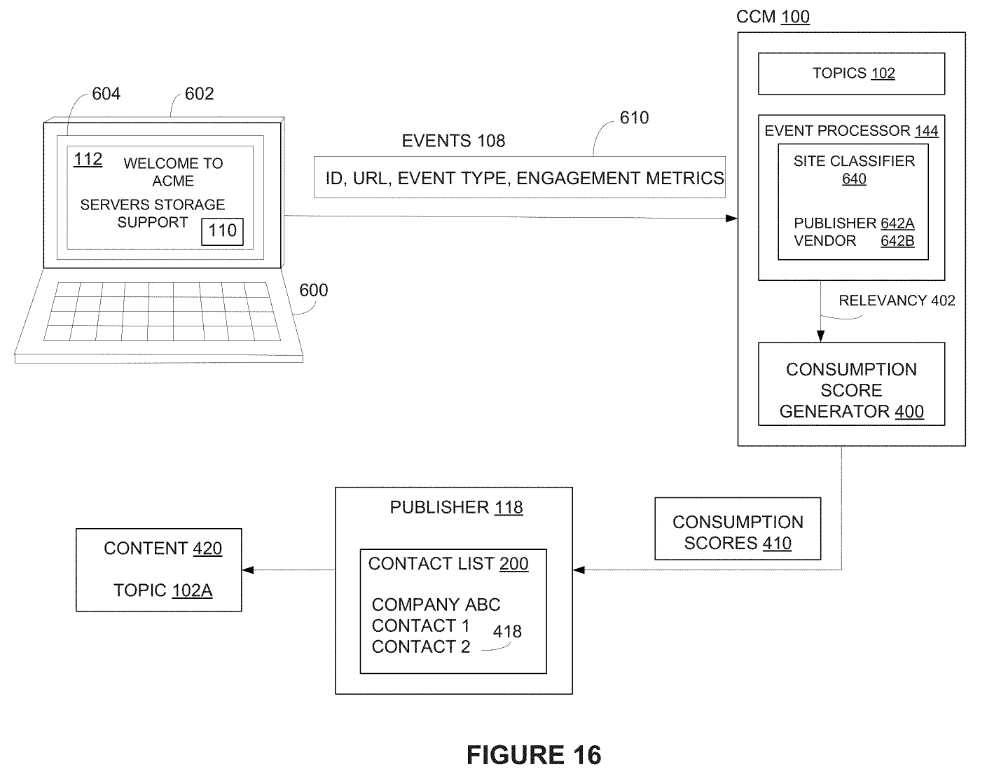

FIG. 16 depicts how CCM 100 may calculate consumption scores based on website classifications. Computer 600 may comprise a laptop, smart phone, tablet or any other device for accessing content 112. In this example, a user may open a web browser 604 on a screen 602 of computer 600. CCM tag 110 may operate within web browser 604 and monitor user web sessions. As explained above, CCM tag 110 may generate events 108 for the web session that include an identifier (ID), a URL for content 112, and an event type that identifies an action or activity associated with content 112. For example, CCM tag 110 may add an event type identifier into event 108 indicating the user downloaded an electronic document.

As also explained above, CCM tag 110 may generate a set of engagement metrics 610 for actions taken by the user while viewing content 112. For example, engagement metrics 610 may indicate how long the user dwelled on content 112 and/or how the user scrolled through content 112. Engagement metrics 610 may indicate a level of engagement or interest the user has in content 112. For example, the user may spend more time on the web page and scroll through the web page at a slower speed when the user is more interested in the content 112.

CCM 100 may adjust consumption scores 410 based on a category of website 642 containing content 112. For example, a first category of website 642A may be associated with a publisher, such as a news reporting company or a blog site. A second category of website 642B may be associated with a vendor, such as a manufacturer or retailer that sells products or services. CCM 100 may adjust relevancy score 402 and resulting consumption scores 410 based on content 112 being located on publisher website 642A or located on vendor website 642B.

For example, it has been discovered that a user may be closer to making a purchase decision when viewing content on a vendor website 642B compared to viewing similar content on a publisher website 642A. Accordingly, CCM 100 may increase relevancy score 402 associated with content 112 located on a vendor website 642B.

CCM 100 may use the increased relevancy score 402 to calculate consumption scores 410 as described above. The website classification-based consumption scores 410 may identify surges 412 as shown in FIG. 9 that more accurately indicate when companies are ready to purchase products or services associated with topics 102.

A publisher website may refer to any website that focuses more on providing informational content compared to content primarily directed to selling products or services. For example, the publisher may be a news service or blog that displays news articles and commentary or a service organization or marketer that publish content. The vendor website contain content primarily directed toward selling products or services and may include websites operated by manufacturers, retailers, or any other intermediary.

Marketer websites may be a sub-category of publisher websites and may refer to websites focusing on the marketing and discussions of different products or services. For example, a marketer website may include online trade magazines or marketing websites for different product and service categories.

News websites may be another sub-category of publisher websites and may refer to websites directed to more general news topics. For example, a news website may include news articles on any current subject matter.

The example explanations below refer to publisher websites, vendor websites, news websites, and marketer websites. However, it should be understood that the schemes described below may be used to classify any category of website that may have an associated structure, content, or type of user engagement. It should also be understood that the classification schemes described below may be used for classifying any group of content including different content located on the same website or content located for example on servers or cloud systems.

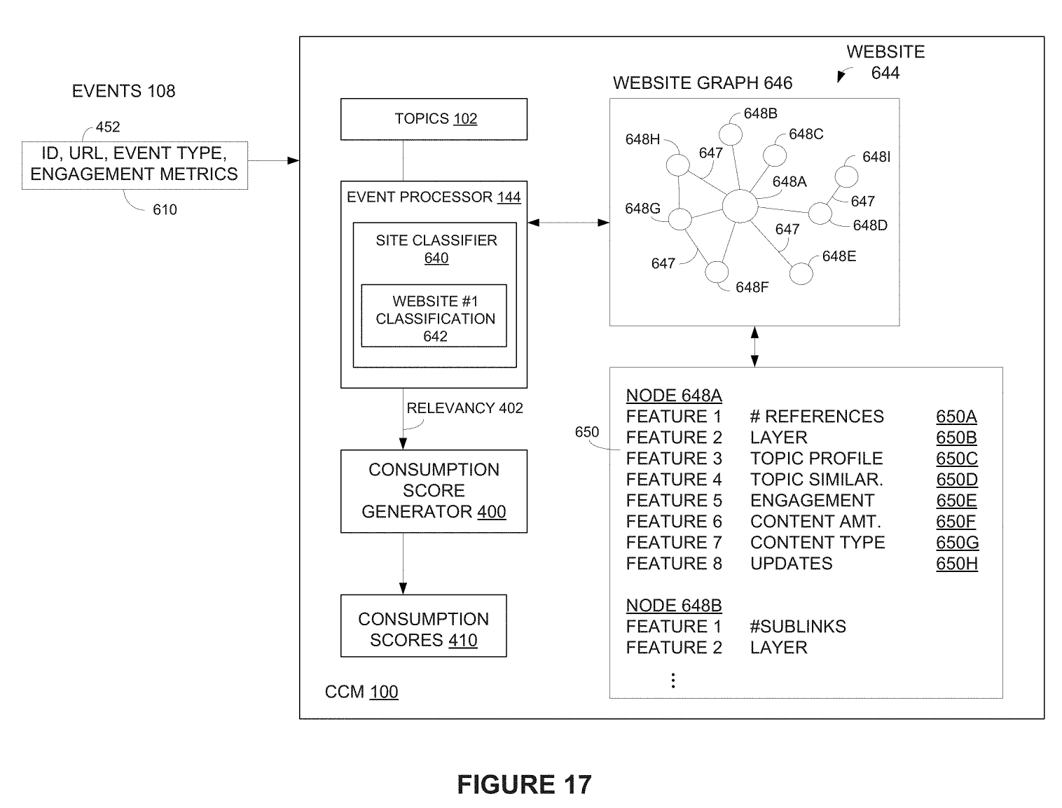

FIG. 17 shows how site classifier 640 operates in more detail. Site classifier 640 may generate graphs 646 to represent websites 644 accessed by users, including explicit representation pieces of content (webpages) and the references (hyperlinks) they have to each other. Each website (graph) 646 may include multiple nodes 648 each associated with a piece of content on website 644. For example, each node 648 may represent a web page on website 644. Graph 646 also may include edges 647 identifying the references between the different nodes 648. For example, a first home page 648A on website 644 may include references to web pages 648B-6481. Web page 648G may include second level references 647 to web pages 648H and 648F. Web page 648D may include a second level references 647 to webpage 6481.

Site classifier 640 may classify website 644 based on the structure of graph 646. For example, home page 648A in graph 646 may include references 647 to many sub-web pages 648B-648H. Graph 646 also may include only a few web page sublevels below home page 648A. For example, nodes 648B-648H are located on a first sub-level below home page 648A. An additional webpage sublevel exists that includes webpage 6481.

A website 644 with a home page 648A with a relatively large number of references 647 to a large number of first level subpages 648B-648H may more likely represent a vendor website 644. For example, a vendor website may include multiple products or services all accessed through the home page. Further, a vendor website 644 may have a relatively small number of lower level references 647 and associated web page sublevels (shallow depth). In this example, site classifier 640 may predict website 644 as associated with a vendor.

In another example, home page 648A may include relatively few references 647 to other webpages 648. Further, there may be many more sublayers of webpages 648 linked to other webpages. In other words, graph 646 may have a deeper tree structure. In this example, site classifier 640 may predict website 644 as associated with a publisher.

Based on the structure of graph 646 in FIG. 17, site classifier 640 may predict website 644 is a vendor website. A company accessing a vendor website may indicate more urgency in a company intent to purchase a product associated with the website. Accordingly, site classifier 640 may increase the relevancy scores 402 produced from content 112 accessed from vendor website 644.

This is just one example of how site classifier 640 may classify websites 644 based on an associated webpage structure. Site classifier 640 also may classify websites 644 based on other features 650 extracted from the HTML in the webpages at the URLs 452 identified in events 108.

Site classifier 640 may first determine if a graph 646 already exists for the website 644 associated with URL 452 in event 108. If a graph 646 already exists, site classifier 640 may check a time stamp in event 108 with a time stamp assigned to graph 646. If a graph 646 has not been created for website 644 or the graph needs updating, site classifier 640 may download the HTML for the webpages on website 644.

Site classifier 640 extracts features 650 for each node/webpage 648 and generates associated graph 646. For each node 648, site classifier 640 may identify the number of references 650A contained in the HTML by inspecting for the HTML for hrefs, anchors, and tags. Site classifier 640 also may identify the sublayer location 650B of node 648 within graph 646. For example, site classifier 640 may identify the fewest number of references 647 separating a node 648 from homepage node 648A.

After identifying layers 650B for each node 648, site classifier 640 may derive graph 646 identifying the relationships between each node 648. While shown graphically in FIG. 17, graph 646 may also or alternatively be generated in a table format that identifies the relationships between different nodes 648 and provides additional graph metrics, such as the number of node layers, the number of nodes on each node layer, and the number of links for each node layer.

As mentioned above, the number of references 650A and/or the association of reference links 647 with other nodes 648 may indicate the structure and associated type of website 644. A deeper tree structure with more lower level nodes 648 linked to other lower level nodes 648 may indicate a publisher website 644. A shallower tree structure with fewer node levels or fewer links at higher node levels may indicate a vendor website 644. Of course, this is just one example of the different structural features that may distinguish different website classes.

Site classifier 640 may generate a topic profile 650C for each node 648. For example, event processor 144 may use content analyzer 142 in FIG. 2 to identify a set of topics contained in the webpage. Topic profile 650C may provide an aggregated view of content on node 648. Site classifier 640 also may generate topic similarity values 650D indicating the similarity of topics on a particular node 648 with topics on other linked nodes 648 on a higher graph level, the same graph level, lower graph levels, or the similarity with topics for unlinked nodes on the same or other graph levels.

The relationships between topics on different nodes 648 also may indicate the type of webpage 648. For example, nodes 648 on a publisher website 644 may be more disparate and have a wider variety of topics 650C than nodes 648 on a vendor website 644. In another example, similar topics for nodes 648 on a same graph level or nodes on a same branch of graph 646 may more likely represent a vendor website.

Site classifier 640 may identify topic similarities 650D by identifying the topics on a first webpage, such as home webpage 648A. Site classifier 640 then compares the home page topics with the content on a second web page. Content analyzer 142 in FIG. 2 then generates a set of relevancy scores indicating the relevancy or similarity of the second webpage to the home page. Of course, site classifier 640 may use other natural language processing schemes to identify topic similarities between different nodes 648. Site classifier 640 may generate topic similarities 650D between any linked nodes 648, nodes associated with a same or different graph levels, or any other node relationship.

Site classifier 640 also may generate engagement feature 650E for each webpage 648. As described above in FIGS. 14 and 15, CCM 100 may generate consumption scores 410 and identify company surges 412 based on user engagement metrics 610. As explained above, engagement feature 650E may indicate a level of engagement or interest the user has the webpage 648. For example, engagement feature 650E may capture information about how long the user dwelled on a particular webpage 648 and/or how the user scrolled through content in the webpage 648. The user may spend more time on a webpage and scroll at a slower speed when more interested in the web page content 112.

Site classifier 640 may use engagement feature 650E to classify website 644. For example, users on a publisher news website 644 may on average spend more time reading articles on individual webpages 648 and may scroll multiple times through relatively long articles. Users on a vendor website 644 may on average spend less time viewing different products and scroll less on relatively short webpages 648. A user also may access a publisher news website more frequently, such as every day or several times a day. The user may access vendor websites 644 much less frequently, such as only when interested in purchasing a particular product.

In addition, users may spend more time on more web pages of a publisher website when there is a particular news story of interest that may be distributed over several publisher news stories. This additional engagement on the publisher website could be mistakenly identified as a company surge, when actually the additional engagement is due to a non-purchasing related news topic. On the other hand, users from a same company viewing multiple vendor websites within a relatively short time period, and/or the users viewing the vendor websites with additional engagement, may represent an increased company urgency to purchase a particular product.

Site classifier 640, or another module in event processor 144, may generate engagement scores 612 for each node 648 on website 644 as described above in FIGS. 14 and 15. Site classifier 640 then may classify website 644 as a publisher based at least partially on webpages 648 having higher engagement scores where users on average spend more time on the webpages, and visit the webpages more frequently. Site classifier 640 may classify website 644 as a vendor website based, at least partially, on webpages 648 having lower engagement scores where users spend less time on the webpage and visit the webpage less frequently, or have engagement scores with higher variance or other statistical characteristics.

Site classifier 640 may generate an average engagement score 612 for the webpages 648 on the same website 644. Site classifier 640 may increase relevancy score 402 when the amount and pattern of engagement scores 612 indicate a vendor website 644 and may reduce relevancy score 402 when the amount and pattern of engagement score 612 indicates a publisher website 644.

Different types of websites may contain different amounts of content. For example, individual webpages 648 on a publisher website 644 may generally contain more text (deeper content) than individual webpages 648 on a vendor website (shallower content). Site classifier 640 may calculate amounts of content 650F for individual webpages 648 in website 644. For example, site classifier 640 may count the number of words, paragraphs, documents, pictures, videos, images, etc. contained in individual webpages 648.

Site classifier 640 may calculate an average amount of content 650F in nodes 648 on the same website 644. An average content amount above some threshold may more likely represent a publisher website 644 and an average amount of content 650F below some threshold may more likely represent a vendor website 644. Site classifier 640 may increase relevancy score 402 when the average amount of content 650F indicates a vendor website 644 and may reduce relevancy score 402 when the average amount of content 650F indicates a publisher website 644.

Different types of websites may contain different types of content. For example, publisher websites 644 may contain more advertisements than vendor website 644. In another example, vendor sites may have a “contact us” webpage, product webpages, purchase webpages, etc. A “contact us” link in a publisher website may be hidden in several levels of webpages compared with a vendor website where the “contact us” link may be located on the home page. A vendor website also may have a more prominent hiring/careers webpage linked directly to home webpage.

Site classifier 640 may identify different types and locations of content 650F in the webpage HTML. For example, site classifier 640 may identify Iframes in the webpage HTML. An IFrame (Inline Frame) is an HTML document embedded inside another HTML document and is often used to insert content from another source, such as an advertisement.

Site classifier 640 also may classify websites 644 based on these other types of content 650G and locations of content 650G. Site Classifier may also identify “infinite scroll” techniques or “virtual page views” that allow a website visitor to continually scroll down an article, and, at end of content, produce a new article to continue reading within the same page without clicking a link. Examples: Forbes.com/BusinessInsider.com.

Site classifier 640 also may classify website 644 based on frequency of content updates 650H. For example, a publisher site may update and/or replace webpage content, such as news articles, more frequently than a vendor website replaces webpage content for products or services. Site classifier 640 may identify topics on the webpages 648 of website 644 on a scheduled frequency, such as every day, week, or month. Additionally, site classifier 640 may receive updates to new content added to a website, through a subscription to RSS feeds, if they exist. RSS feeds are an industry established way for website content producers to push notifications of new and updated material to a consumer. Site classifier 640 may generate an update value 650H indicating the frequently of topics changes on the webpages and/or website. A higher update value 650H may indicate a publisher site and a lower update value may indicate a vendor website.

Site classifier 640 may use any combination of features 650 to classify website 644. Site classifier 640 also may weight some features 650 higher than other features. For example, site classifier 640 may assign a higher vendor score to a website 644 identified with a shallow graph structure 646 compared with identifying website 644 with relatively shallow content 650F. Site classifier 640 generates a classification value for website 644 based on the combination of features 650 and associated weights. Site classifier 640 then adjusts relevancy 402 based on the classification value. For example, site classifier 640 may increase relevancy score 402 or consumption score 410 more for a larger vendor classification value and may decrease relevancy score 402 or consumption score 410 more for a larger publisher classification value.

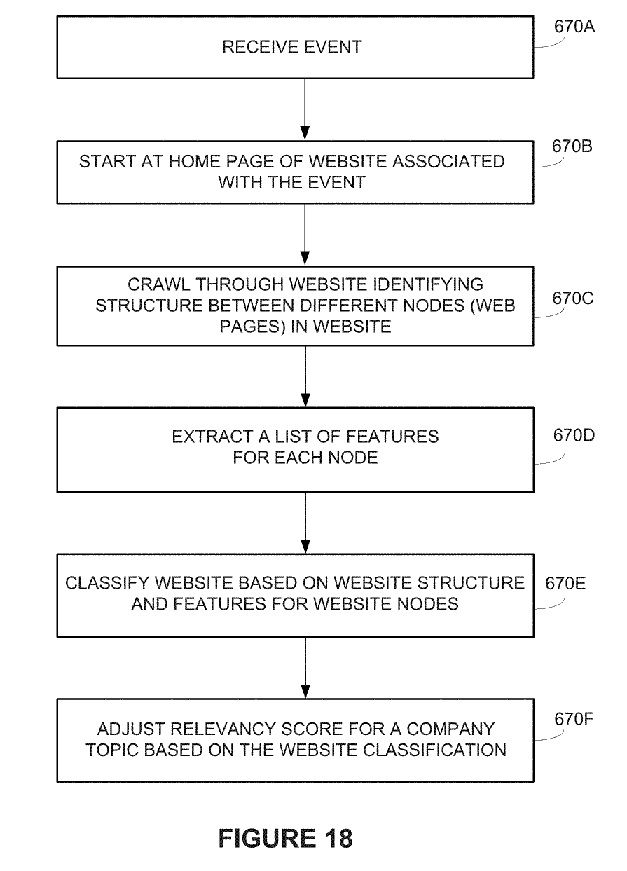

FIG. 18 shows an example process for identifying company surge scores based on website classifications. In operation 670A, the site classifier may receive an event that includes a user ID, URL, event type, engagement metrics, and any other information identifying content or an activity on a webpage. The site classifier first may determine if a graph 646 already exists on the website associated with the URL. If an up to date graph 646 exists, the site classifier may have already classified the website. If so, site classifier may adjust any derived relevancy scores based on the website classification.

Otherwise, the site classifier in operation 670B may start at the home page of the website associated with the received event. In operation 670C, the site classifier may crawl through the website identifying the structure between nodes. For example, the site classifier identifies links on the home page to other webpages. The site classifier then identifies links in the HTML of the lower level pages to other pages to generate a website graph or tree structure as shown in FIG. 17.

In operation 670D, the site classifier extracts other features from the webpages as described above. For example, the site classifier identifies the number of references, layers of webpages, topics, interaction amounts and types of content, number of updates, etc. associated with each webpage. In operation 670E, the site classifier classifies the website based on the website structure and other node features. For example, the site classifier may use any combination of the features discussed above to generate a classification value for the website.

As explained above, the site classifier also may weigh different node features differently. For example, the site classifier may assign a larger weight to a website graph structure indicating a publisher website and assign a lower weight to a particular type of content associated with publisher websites.

Based on all of the weighted features, the site classifier may generate the classification value predicting the type of website. In operation 670F, the site classifier may adjust the relevancy score for company topics based on the classification value. For example, site classifier may increase the relevancy score more for a larger vendor classification value and may reduce the relevancy score more for a larger publisher classification value.

### Website Fingerprinting Using Vectors

Site classifier 640 may generate vectors that represent the different features of webpages and websites. Site classifier 640 uses a machine learning model to then classify the different websites based on the feature vectors. The feature vectors are alternatively referred to as webpage embeddings and provide more accurate website classifications while using fewer computing resources in a classification task.

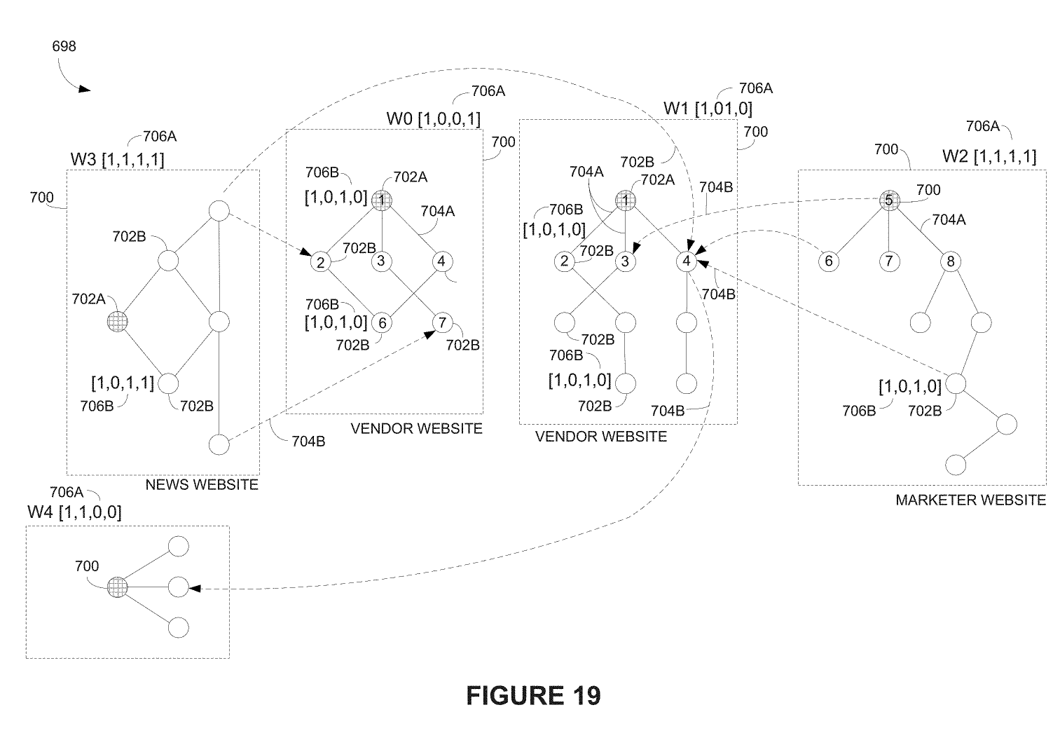

FIG. 19 shows an example structure for a network 698 that includes multiple websites 700 alternatively referred to as sites W0, W1, W2, W3, and W4. In one example, websites 700 may be associated with different types of organizations referred to as classes. For example, W0 and W1 may be vendor websites, W2 may be a marketer website, W3 may be a news website, and W4 may be any other class of website.

As explained above, vendor websites W0 and W1 may contain content primarily directed toward selling or promoting products or services and may include websites operated by manufacturers, retailers, or any other intermediary. Marketer websites W2 may be operated by organizations that provide content directed to marketing or promoting different products, such as an online trade magazine. News websites W3 may be operated by news services or blogs that contain news articles and commentary on a wide variety of different subjects. Website W4 may be any other class of website. For example, website W4 may be a website operated by an individual or operated by an entity not primarily focused on selling products or services.

Each website 700 includes a collection of webpages 702 alternatively referred to as nodes. Each website 700 may include a root webpage or node 702A and a set of other lower tiered nodes 702B. Each webpage 702 has a specific universal resource locator (URL) alternatively referred to as a link 704. Webpages 702 may include URLs 704A that link to other webpages 702 within the same website 700. Webpages 702 also may include URLs 704B that link to webpages 702 on other websites 700.

### Structural Semantics

Across websites 700, the relationships (links 704A) between webpages 702 on the same websites 700 and relationships (links 704B) between webpages 702 on other websites 700 are referred to generally as structural semantics. In one example, site classifier 640 uses links 704 to capture the structural semantics across all websites 700.

As explained above, vendor websites W0 and W1 may have different structural semantics than marketer website W2 or news website W3. For example, vendor website W0 may have a different tree structure of links 704A from root page 702A to lower pages 702B compared with marketer website W2 or news website W3. Vendor websites W0 and W1 also may have more links from root page 702A to lower level webpages 702B. Vendor website W0 also may have relatively fewer links 704B to other websites 700, compared with marketer website W2 or news website W3.

In this example, there are no external links 704B connecting the two vendor websites W0 and W1 together. However, marketer website W2 and news website W3 may discuss products or services sold on vendor websites W0 and W1 and therefore may include more external links 704B to these websites. Thus, marketer website W2 and news website W3 may have the unique quality of including more links 704B to webpages on vendor websites W0 and W1.

In one example, a web crawler walks through each website 700 to identify what is conceptually equivalent to a language for network 698. The network crawler may start from a particular node 702 in a website 700 and identify paths to other nodes. For example, the crawler may identify the following path [2, 1, 3, 5, 8] formed by links 704 in webpages 702 referencing other webpages 702.

In this example, node 2 in website W1 is linked through a hyperlink 704A to node 1 in website W1, node 1 in website W1 is linked through another hyperlink 704A to node 3 in website W1, node 3 in website W1 is linked through another hyperlink 704B to node 5 in website W2, and node 5 in website W2 is linked through another hyperlink 704A to node 8 in website W2, etc.

Generated path [2, 1, 3, 5, 8] is conceptually equivalent to a sentence of words, effectively representing an instance of a natural language structure for network 698. Word embedding techniques in Natural Language Processing, such as Word2Vec (as referenced below) are used to convert individual words found across numerous examples of sentences within a corpus of documents into low-dimensional vectors, capturing the semantic structure of their proximity to other words, as exists in human language. Similarly, website/network (graph) embedding techniques such as LINE, DeepWalk or GraphSAGE can convert sequences of pages found across a collection of referenced websites into low-dimensional vectors, capturing the semantic structure of their relationship to other pages.

Site classifier 640 uses natural language processing to convert the different paths, such as path [2, 1, 3, 5, 8] for node 2, into structural semantic vector 706B. Vector 706B is alternatively referred to as an embedding. Site classifier 640 may generate structural semantic vectors 706B for each webpage 702 in the same website 700. Site classifier 640 then combines the structural semantic vectors 706B for the same website 700 together via a summation to generate a website structural semantic vector 706A. Site classifier 640 feeds website vectors 706A into a logistic regression model that then classifies website 700 as a vendor, marketer, or news provider.

### Site Semantic Features and Interaction Features

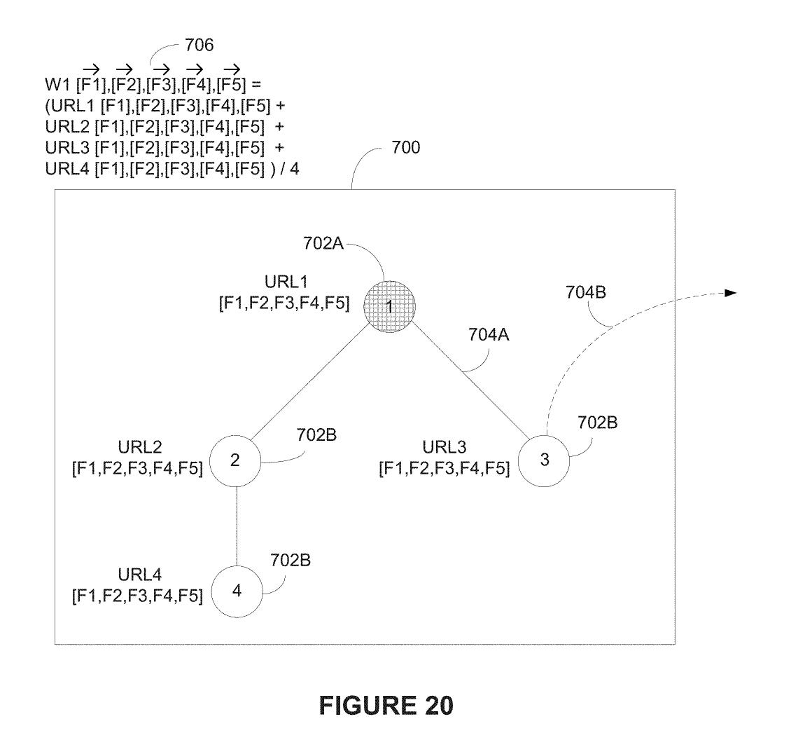

FIG. 20 shows in more detail one particular website 700. As mentioned above, site classifier 640 may classify website 700 based on structural semantic features. Site classifier 640 may generate and use additional features of webpages 702 to classify website 700. Features generated by site classifier 640 may include but is not limited to the following.

Feature F1: Structural semantics. As explained above, structural semantics F1 may be generated based on the structural relationships between webpages 702 provided by hyperlinks 704.

Feature F2: Content semantics. Content semantics F2 may capture the language and metadata semantics of content contained within webpages 702. For example, a machine-learning trained natural language processor model may predict topics associated with the content, such as sports, religion, politics, fashion, or travel. Of course, any other topic taxonomy may be considered to predict topics from webpage content. In addition, site classifier 640 can also identify content metadata, such as the breath of content, number of pages of content, number of words in webpage content, number of topics in webpage content, number of changes in webpage content, etc. Content semantics F2 also may include any other HTML elements that may be associated with different types of websites, such as Iframes, document object models (DOMs), etc.

Similar to structural semantic F1, vendor, marketing, and news websites 700 may have different content semantics F2. For example, a news website W3 may include content with more topics compared with a vendor website W0 that may be limited to a small set of topics related to their products or services. Content on news website W3 also may change more frequently compared to vendor website W0. For example, content on news website W3 may change daily and content on vendor website W0 related to products or services may change weekly or monthly.

Feature F3: B2B Topic Semantic. B2B topics identify different business topics contained in the webpage content. Identifying B2B topics and generating associated topic vectors is described above in FIG. 2. For example, CCM 100 may identify different business related topics in each webpage 702, such as network security, servers, virtual private networks, etc. Of course, any other topic may be identified in webpage content.

Feature F4: Content Interaction Behavior. Content interaction behavior is alternatively referred to as content consumption or content use. Content interaction behavior identifies patterns of user interaction/consumption on webpages 702. For example, news site W3 in FIG. 19 may receive more continuous user interaction/consumption throughout the day and over the entire week and weekend. Marketer website W2 (Trade publications) and vendor sites W0 and W1 may have more volatile user consumption mostly restricted to work hours during the work week.

Types of user consumption reflected in feature F4 may include, but is not limited to time of day, day of week, total amount of content consumed/viewed by the user, percentages of different device types used for accessing webpages 702, duration of time users spend on the webpage and total engagement user has on the webpage, the number of distinct user profiles accessing the webpage vs. total number of events for the webpage, dwell time, scroll depth, scroll velocity, and variance in content consumption over time.

Identifying different event types associated with these different user content interaction behaviors (consumption) and associated engagement scores is described in more detail above. For example, site classifier may 640 may generate the content interaction feature F4 based on the event types and engagement metrics identified in events 108 associated with each webpage 702.

Feature F5: Entity Type. The entity type feature identifies types or locations of industries, companies, organizations, bot-based applications or users accessing the webpage. For example, CCM 100 may identify each user event 108 as associated with an enterprise, small-medium business (SMB), educational institutions, mobile network operators, hotel, web-crawling applications etc. Identifying types of businesses or locations accessing webpages is described in U.S. patent application Ser. No. 16/163,283, Entitled ASSOCIATING IP ADDRESSES WITH LOCATIONS WHERE USERS ACCESS CONTENT, filed Oct. 17, 2018, which is herein incorporated by reference in its entirety.

Structural semantics F1, content semantics F2, and B2B topics F3 are together referred to as website semantic features. Content interaction behavior F4 and entity type F5, and any other user interactions with webpages is referred to as behavioral features.

In one example, site classifier 640 generates one or more feature vectors F1-F5 for each webpage 702. Site classifier 640 then combines all of the same webpage feature vectors to generate an overall website feature vector 706. For example, site classifier 640 may add together the structural semantics feature vectors F1 generated for each of the individual webpages 702 in website 700. Site classifier 640 then divides the sum by the number of webpages 702 to generate an average structural semantics feature vector F1 for website 700.

Site classifier 640 performs the same averaging for each of the other features F2-F5 to form a combined feature vector 706. Site classifier 640 feeds combined feature value 706 into a computer learning model that classifies website 700 as either a vendor, marketer, or news site. Again, this is just one example, and any combination of features F1-F5, or any other features, can be used to classify website 700.

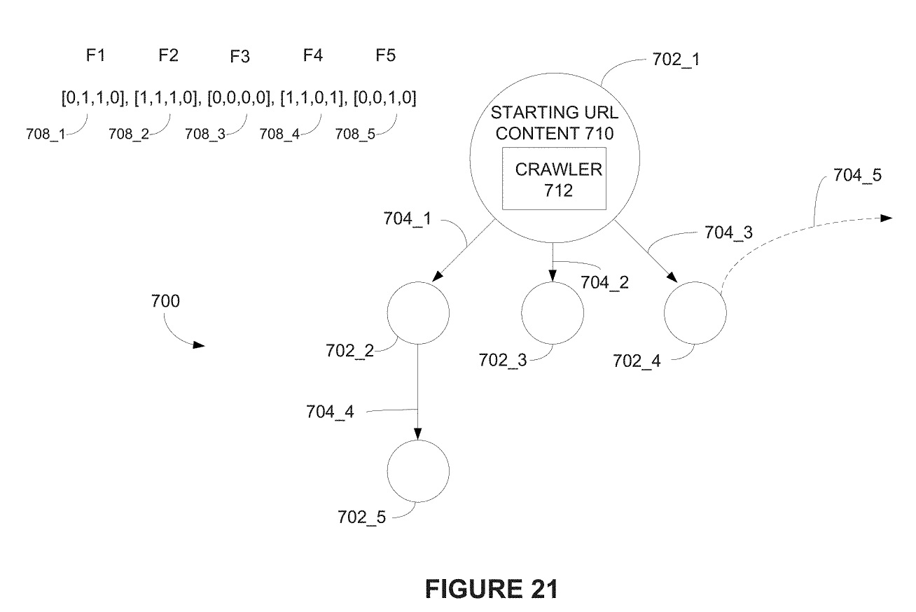

FIG. 21 shows in more detail how site classifier 640 generates vectors 708 for features F1-F5. As explained above, CCM 100 may obtain webpage content 710 from millions of websites 700. Content 710 may include the hypertext markup language (HTML) from each webpage 702. Content 710 may include any text, video, or audio data included with the HTML.

Multiple web crawlers 712 may start at random webpages 702 within different websites and walk different paths through other web pages 702. Web crawlers 712 identify the different paths through the different webpages as explained above in FIG. 19. The paths are used for generating the structural semantics of each webpage 702. Content 710 for each webpage 702 is parsed to identify the different content semantics. Independent of the features generated from web crawling, content consumption events associated with each webpage are also processed to identify the behavioral features of each webpage 702.

Vectors 708 are then generated for each of the identified features F1-F5. In this example, vector 708_1 represents the structural semantics feature F1 for webpage 702_1, vector 708_2 represents the content semantics feature F2 for webpage 702_1, vector 708_3 represents the topic feature F3 for webpage 702_1, vector 708_4 represents the content interaction feature F4 for webpage 702_1, and vector 708_4 represents the entity type feature F5 for webpage 702_1.

Crawler 712 fetches HTML for a webpage 702_1. Crawler 712 finds a link 704_1 to a next lower webpage 702_2. Crawler 712 then parses the HTML for webpage 702_2 for any other links. In this example, crawler 712 identifies a link 704_4 to a next lower level webpage 702_5. Crawler 712 then parses HTML for webpage 702_5 for any other links. In this example, there are no additional links in webpage 702_5.

Crawler 712 then parses the HTML in webpage 702_1 for any additional links. In this example, crawler 712 identifies a next link 704_2 to another lower level webpage 702_3. Crawler 712 parses the HTML in webpage 702_3 and determines there are no additional links.

Crawler 712 further parses the HTML in webpage 702_1 and identifies a third link 704_3 to webpage 702_4. Crawler 712 parses the HTML in webpage 702_4 and identifies an external link 704_5 to a webpage located on a different website. Crawler 712 then parses the HTML on the webpage located on the other website for other links as described above.

Crawler 712 continues crawling webpages until detecting a convergence of the same webpages on the same websites. Otherwise, crawler 712 may stop crawling through a web path if no new webpages or websites are detected after some threshold number of hops. Crawler 712 then may crawl through the next link in webpage 702_1. When all links in webpage 702_1 are crawled, crawler 712 may start crawling the remaining links in the next webpage 702_2.

As explained above, the different paths identified by web crawler 712 through webpage 702_1, such as path [2, 1, 3, 5, 8] described above in FIG. 19, are converted by an unsupervised learning model, such as DeepWalk (Perozzi, Bryan et al. “DeepWalk: online learning of social representations.” KDD (2014)), LINE (Tang, Jian et al. “LINE: Large-scale Information Network Embedding.” WWW (2015)), or GraphSAGE (Hamilton, William L. et al. “Inductive Representation Learning on Large Graphs.” NIPS (2017)) into structural semantic vector 708_1.

Values in vector 708_1 may represent different structural characteristics of webpage 702_1. For example, values in vector 708_1 may indicate the hierarchical position of webpage 702_1 within website 700, the number of links to other webpages within website 700, the number of links to other webpages outside of website 700, etc. Structural semantic vector 708_1 may capture first order proximity identifying direct relationships of webpage 702_1 with other webpages. Vector 708_1 also may capture second order proximity identifying indirect relationships of webpage 702_1 with other webpages through intermediate webpages.

A natural language processor analyzes content 710 to generate a vector 708_2 for content semantic feature F2. The natural language machine learning algorithm may identify subjects, number or words, number of topics, etc. in the text of webpage 702_1. The natural language processor converts the identified topics, sentence structure, word count, etc. into content semantic vector 708_2. A content semantic vector 708_2 is generated for each webpage 702 in website 700.

Content semantic vectors 708_2 for different webpages 702 are easily compared to identify webpage or website similarities and differences which may provide further insight into website classification. For example, a cosine similarity operation may be performed for different content semantic vectors 708_2 to determine the similarity of topics for webpages 702 on the same websites 700 or to determine the similarities between topics on different websites 700.

One example machine learning algorithm for converting text from a webpage into content semantic vector 708_2 is Word2Vec described in Mikolov, Tomas et al. “Efficient Estimation of Word Representations in Vector Space.” CoRR abs/1301.3781 (2013), which is herein incorporated by reference in its entirety. Converting text into a multidimensional vector space is known to those skilled in the art and is therefore not described in further detail.

Site classifier 640 may generate a vector 708_3 for topic feature F3. As described above, content analyzer 142 in FIG. 2 above generates topic vectors 136 for different webpages. Site classifier 640 may use a similar content analyzer to generate B2B topic vector 708_3 for webpage 702_1. Each value in B2B topic vector 708_3 may indicate the probability or relevancy score of an associated business related topic within content 710. In one example, content semantics vector 708_2 may represent a more general language structure in content 710 and B2B topic vector 708_3 may represent a more specific set of business related topics in content 710.

Site classifier 640 generates a vector 708_4 for content interaction feature F4. Vector 708_4 identifies different user interactions with webpage 702_1. Site classifier 640 may generate vector 708_4 by analyzing the events 108 associated with webpage 702_1. For example, each event 108 described above may include an event type 456 and engagement metric 610 identifying scroll, time duration on the webpage, time of day, day of week webpage was accessed, variance in consumption, etc. Each value in vector 708_4 may represent a percentage or average value for an associated one of the event types 456 for a specified time period.

For example, site classifier 640 may identify all of the events 108 for a specified time period associated with webpage 702_1. Site classifier 640 may generate content interaction vector 708_4 by identifying all of the same event types in the set of events 108. Site classifier 640 then may identify the percentage of events 108 associated with each of the different event types. Site classifier 640 uses each identified percentage as a different value in content interaction vector 708_4.

For example, a first value in content interaction vector 708_4 may indicate the percentage of events generated for webpage 702_1 during normal work hours and a second value in content interaction vector 708_4 may indicate the percentage or ratio of events generated for webpage 702_1 during non-work hours. Other values in content interaction vector 708_4 may identify any other user engagement or change of user engagement with webpage 702_1.

Site classifier 640 generates a vector 708_5 for entity type feature F5. Vector F5 identifies different types of users interacting with webpage 702_1. Site classifier 640 may generate vector 708_5 by analyzing all of the events 108 associated with webpage 702_1. For example, each event 108 may include an associated IP address. As mentioned above, CCM 100 may identify the IP address as being associated with an enterprise, small-medium business (SMB), educational entity, mobile network operator, hotel, etc.

Site classifier 640 identifies the events 104 associated with webpage 702_1 for a specified time period. Site classifier 640 then identifies the percentage of the events associated with each of the different entity types. For example, site classifier 640 may generate an entity type vector 708_5=[0.23, 0.20, 0.30, 0.17, 0.10] where [% enterprise, % small medium business, % education, % mobile network operators, % hotels].

As mentioned above in FIG. 20, site classifier 640 calculates the average for feature vectors 708_1, 708_2, 708_3, 708_4, and 708_5 generated for all of the webpages 702 associated with the same website 700 to generate an overall website feature vector 706 as shown in FIG. 20. Each of the different features F1-F5 provide additional information for more accurate site classifications.

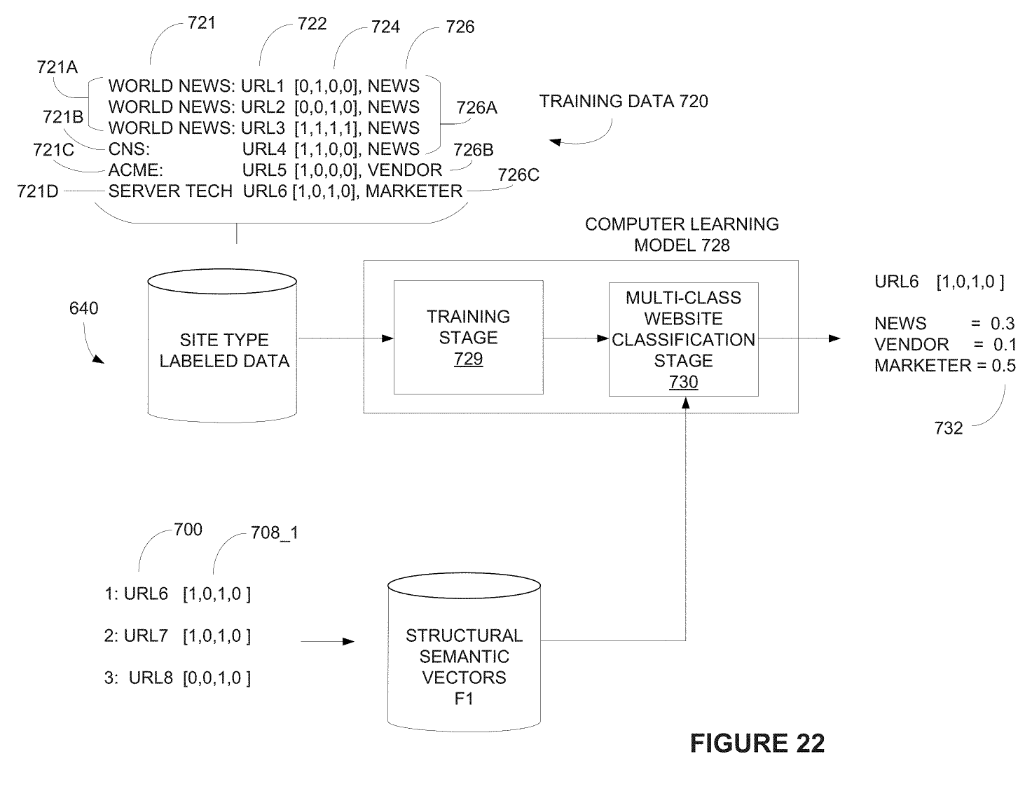

FIG. 22 shows how site classifier 640 classifies a website based on structural semantic feature F1. However, it should be understood that site classifier 640 may classify websites based on any combination of features F1-F5 described above.

Site classifier 640 may receive a set of training data 720 that includes the URLs 722 and associated structural semantic (SS) vectors 724 for a set of known webpages. Site classifier 640 may crawl through a set of webpages (URLs 722) on websites 721 with known classifications 726. For example, a known news website 721A may include three webpages with URL1, 2, and 3. Site classifier 640 may crawl each URL 1, 2, and 3 over a previous week to generate associated SS vectors 724. URLs 1, 2, and 3 are from a known news website and accordingly are manually assign news classification 726A.

Site classifier 640 also generates SS vectors 724 for URL4 associated with another known news website 721B, URLS associated with a known vendor website 721C, and URL6 associated with a known marketer website 721D. Of course, SS vectors 724 may be generated for each webpage 722 on each of websites 721. The operator assigns each SS vector 724 its known site classification 726.

Site classifier 640 feeds training data 720 that includes SS vectors 724 and the associated known site classifications 726 into a computer learning model 728. For example, computer learning model 728 may be a logistic regression (LR) model or Random Forest model. Of course, other types of supervised computer learning models can also be used. Computer learning model 728 uses training data 720 during a training stage 729 to identify the characteristics of SS vectors 724 associated with each site classification 726. After model 728 has completed training stage 729, it then operates as a site classifier in website classification stage 730.

Structural semantic vectors 708_1 are generated for different websites 700 with unknown classification as described above. SS vectors 708_1 are fed into model 728. Model 728 generates site prediction values 732 for each website 700. For example, computer learning model 728 may predict the website associated with URL6 as having a 0.3 likelihood of being a news website, 0.1 likelihood of a vendor website, and a 0.5 likelihood of a marketer website.

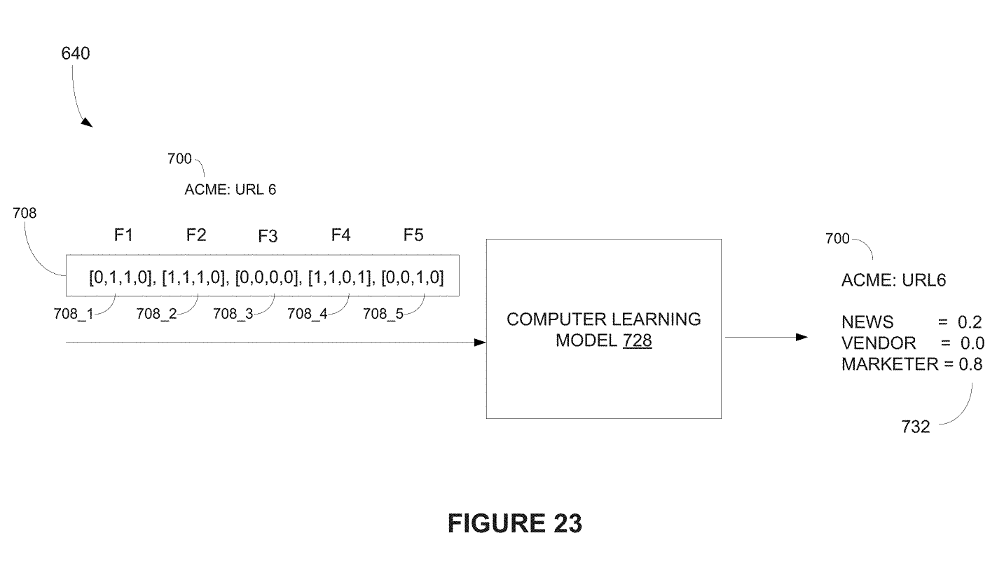

FIG. 23 shows in more detail how site classifier 640 uses multiple feature vectors 708 to classify website 700. In this example, website 700 is associated with URL6. Site classifier 640 generates vector 708_1 from the structural semantic features F1 of the webpages in website 700, and generates vector 708_2 from the content semantic features F2 of the webpages in website 700. Site classifier 640 generates vector 708_3 from the topic features F3 identified in the webpages in website 700. Site classifier 640 analyzes the events associated with each webpage of website 700 and generates vector 708_4 from the user interaction features F4 and generates vector 708_5 from the entity type features F5 associated with the webpages of website 700.

Computer learning model 728 is trained as explained above with any combination of vectors 708_1, 708_2, 708_3, 708_4, and 708_5 generated from websites with known classifications. Vectors 708 are generated from website 700 with an unknown classification and fed into a machine learning trained classifier model 728. Model 728 generates site predictions 732 for website 700. In this example, model 728 may more accurately predict website 700 as a marketer website due to the additional features F2, F3, F4, and F5 used for classifying website 700.

As mentioned, site classifications 732 can be used as another event dimension for determining user or company intent and surge scores. For example, a large surge score from a vendor website may have more significance for identifying a company surge than a similar surge score on a news or marketing website. Site classifications 732 can also be used for filtering different types of data. For example, CCM 100 can capture and determine surge scores from events 108 generated for one particular website class.

### Hardware and Software

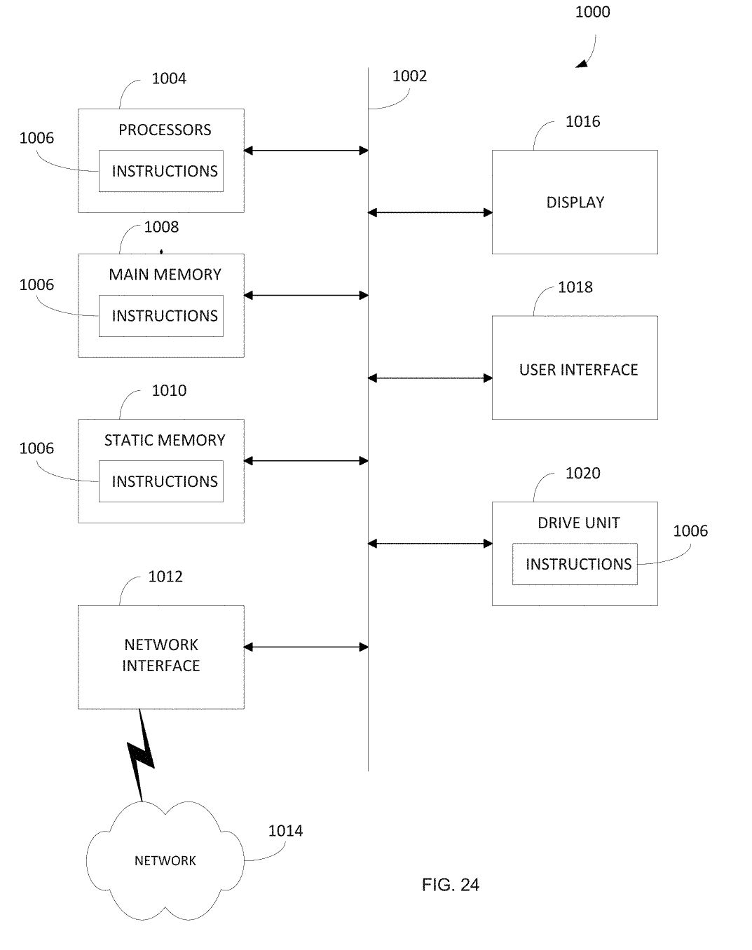

FIG. 24 shows a computing device 1000 that may be used for operating the content consumption monitor and performing any combination of processes discussed above. The computing device 1000 may operate in the capacity of a server or a client machine in a server-client network environment, or as a peer machine in a peer-to-peer (or distributed) network environment. In other examples, computing device 1000 may be a personal computer (PC), a tablet, a Personal Digital Assistant (PDA), a cellular telephone, a smart phone, a web appliance, or any other machine or device capable of executing instructions 1006 (sequential or otherwise) that specify actions to be taken by that machine.

While only a single computing device 1000 is shown, the computing device 1000 may include any collection of devices or circuitry that individually or jointly execute a set (or multiple sets) of instructions to perform any one or more of the operations discussed above. Computing device 1000 may be part of an integrated control system or system manager, or may be provided as a portable electronic device configured to interface with a networked system either locally or remotely via wireless transmission.

Processors 1004 may comprise a central processing unit (CPU), a graphics processing unit (GPU), programmable logic devices, dedicated processor systems, micro controllers, or microprocessors that may perform some or all of the operations described above. Processors 1004 may also include, but may not be limited to, an analog processor, a digital processor, a microprocessor, multi-core processor, processor array, network processor, etc.

Some of the operations described above may be implemented in software and other operations may be implemented in hardware. One or more of the operations, processes, or methods described herein may be performed by an apparatus, device, or system similar to those as described herein and with reference to the illustrated figures.

Processors 1004 may execute instructions or “code” 1006 stored in any one of memories 1008, 1010, or 1020. The memories may store data as well. Instructions 1006 and data can also be transmitted or received over a network 1014 via a network interface device 1012 utilizing any one of a number of well-known transfer protocols.

Memories 1008, 1010, and 1020 may be integrated together with processing device 1000, for example RAM or FLASH memory disposed within an integrated circuit microprocessor or the like. In other examples, the memory may comprise an independent device, such as an external disk drive, storage array, or any other storage devices used in database systems. The memory and processing devices may be operatively coupled together, or in communication with each other, for example by an I/O port, network connection, etc. such that the processing device may read a file stored on the memory.

Some memory may be “read only” by design (ROM) by virtue of permission settings, or not. Other examples of memory may include, but may be not limited to, WORM, EPROM, EEPROM, FLASH, etc. which may be implemented in solid state semiconductor devices. Other memories may comprise moving parts, such a conventional rotating disk drive. All such memories may be “machine-readable” in that they may be readable by a processing device.

“Computer-readable storage medium” (or alternatively, “machine-readable storage medium”) may include all of the foregoing types of memory, as well as new technologies that may arise in the future, as long as they may be capable of storing digital information in the nature of a computer program or other data, at least temporarily, in such a manner that the stored information may be “read” by an appropriate processing device. The term “computer-readable” may not be limited to the historical usage of “computer” to imply a complete mainframe, mini-computer, desktop, wireless device, or even a laptop computer. Rather, “computer-readable” may comprise storage medium that may be readable by a processor, processing device, or any computing system. Such media may be any available media that may be locally and/or remotely accessible by a computer or processor, and may include volatile and non-volatile media, and removable and non-removable media.

Computing device 1000 can further include a video display 1016, such as a liquid crystal display (LCD) or a cathode ray tube (CRT) and a user interface 1018, such as a keyboard, mouse, touch screen, etc. All of the components of computing device 1000 may be connected together via a bus 1002 and/or network.

For the sake of convenience, operations may be described as various interconnected or coupled functional blocks or diagrams. However, there may be cases where these functional blocks or diagrams may be equivalently aggregated into a single logic device, program or operation with unclear boundaries.

Having described and illustrated the principles of a preferred embodiment, it should be apparent that the embodiments may be modified in arrangement and detail without departing from such principles. Claim is made to all modifications and variation coming within the spirit and scope of the following claims.

1. A computer program stored on a non-transitory storage medium, the computer program comprising a set of instructions, when executed by a hardware processor, cause the hardware processor to:
identify one or more features from training websites with known classifications;
train a computer learning model with the features and known classifications;
identify the features from an unclassified website with an unknown classification; and
apply the features from an unclassified website to the trained computer learning model to predict a classification for the unclassified website.

2. The computer program of claim 1, wherein the set of instructions, when executed by a hardware processor, further cause the hardware processor to:
generate a first set of vectors representing the features of the training websites;
use the first set of vectors and known classifications of the training websites to train the computer learning model;
generate a second set of vectors representing the features of the unclassified website; and
apply the second set of vectors to the trained computer learning model to classify the unclassified website.

3. The computer program of claim 1, wherein one of the features identifies structural semantics of webpages in the websites.

4. The computer program of claim 3, wherein the set of instructions, when executed by a hardware processor, further cause the hardware processor to:
crawl the webpages of the unclassified website to identify links between the webpages on the website and links with other webpages on the same website and links with webpages on other websites; and
identify the structural semantics of the website based on the identified links.

5. The computer program of claim 1, wherein the set of instructions, when executed by a hardware processor, further cause the hardware processor to generate one of the features that identify content semantics of webpages in the websites.

6. The computer program of claim 5, wherein the set of instructions, when executed by a hardware processor, further cause the hardware processor to:
crawl the webpages of the unclassified website to identify types of content and topics in the webpages; and
identify the content semantics of the website based on the identified types of content and topics in the webpages.

7. The computer program of claim 1, wherein the set of instructions, when executed by a hardware processor, further causes the hardware processor to generate one of the features that identify content interaction behavior with webpages in the websites.

8. The computer program of claim 7, wherein the set of instructions, when executed by a hardware processor, further cause the hardware processor to:
identify events associated with the webpages of the websites;
identify types of user interactions with the webpages identified in the events;
identify the content interaction behavior based on the types of user interactions with the webpages.

9. The computer program of claim 1, wherein the set of instructions, when executed by a hardware processor, further cause the hardware processor to generate one of the features that identifies types of users accessing webpages in the websites.

10. The computer program of claim 9, wherein the set of instructions, when executed by a hardware processor, further cause the hardware processor to:
identify events associated with the webpages of the websites;
identify types of users associated with the events; and
identify the types of users accessing the webpages based on the types of users identified in the events.

11. An apparatus, comprising:
a processing device;
a memory device coupled to the processing device, the memory device having instructions stored thereon that, in response to execution by the processing device, are operable to:
identify a website semantic feature for a website;
identify a website behavioral feature for the website;
predict a classification for the website based on the website semantic feature and the website behavioral feature.

12. The apparatus of claim 11, wherein the instructions in response to execution by the processing device, are further operable to:
generate a first vector representing the website semantic feature of the website;
generate a second vector representing the website behavioral feature of the website;
feed the first and second vector into a computer learning model to predict the classification for the website.

13. The apparatus of claim 11, wherein the instructions in response to execution by the processing device, are further operable to generate the website semantic feature for the website based on links between webpages on the website.

14. The apparatus of claim 13, wherein the instructions in response to execution by the processing device, are further operable to generate the website semantic feature for the website based on content and topics in the webpages on the website.

15. The apparatus of claim 11, wherein the instructions in response to execution by the processing device, are further operable to generate the website behavioral feature for the website based on types of user interactions with webpages on the website.

16. The apparatus of claim 15, wherein the instructions in response to execution by the processing device, are further operable to generate the website behavioral feature for the website based on types of businesses accessing the webpages on the website.
